(19) United States
(12) Patent Application Publication
(10) Pub. No.: US 2023/0409345 A1
(43) Pub. Date: Dec. 21, 2023

(54) OPTIMIZATION DEVICE, OPTIMIZATION METHOD, AND OPTIMIZATION PROGRAM

(71) Applicant: NIPPON TELEGRAPH AND TELEPHONE CORPORATION, Tokyo (JP)

(72) Inventors: Ippei SHAKE, Tokyo (JP); Chihiro YAMAMOTO, Tokyo (JP)

(73) Assignee: NIPPON TELEGRAPH AND TELEPHONE CORPORATION, Tokyo (JP)

(21) Appl. No.: 18/035,468

(22) PCT Filed: Nov. 13, 2020
(86) PCT No.: PCT/JP2020/042529

§ 371 Date: May 4, 2023

(51) Int. Cl. G06F 9/445

(52) U.S. Cl. CPC G06F 9/44505

(57) ABSTRACT

An optimization device 10 for optimizing a digital twin system including at least two digital twins includes: an index value acquisition unit 101 that acquires a first index value of a first digital twin in a case where a first parameter is given; a state estimation unit 102 that estimates a state of the first digital twin after the first parameter is given; a state acquisition unit 103 that acquires the state of the first digital twin, a second index value of a second digital twin obtained in a case where the first parameter is given, and a state of the second digital twin; and an optimization unit 104 that optimizes the first index value and the second index value.

### TECHNICAL FIELD

The disclosed technology relates to an optimization device, an optimization method, and an optimization program.

### BACKGROUND ART

It has been conventionally studied to model an object or event existing in a real space on a computer and feed back a result of simulation performed on the computer to the real space. An object or event obtained by modeling the object or event existing in the real space on the computer will be hereinafter referred to as a digital twin or DT.

For example, Non Patent Literature 1 discloses an example where individual wind power generators are customized by using their digital twins.

### CITATION LIST

### Non Patent Literature

Non Patent Literature 1: Mitsui & Co. Global Strategic Studies Institute, Strategic Studies Institute's Report, Jan. 31, 2017, “Four Innovations to Focus on in 2017”, https://www.mitsui.com/mgssi/ja/report/detail/_icsFiles/afieldfile/2017/02/09/170131tm.pdf

### SUMMARY OF INVENTION

### Technical Problem

However, conventional technologies including Non Patent Literature 1 consider only a digital twin of one object. Non Patent Literature 1 discloses that there is an attempt to achieve not only the wind power generators described above but also city planning or the like by using digital twins, but only discloses creating digital twins of individual objects.

A large number of objects exist in the real space and affect each other. This indicates that it is also necessary to consider that digital twins affect each other. For example, there is a case of performing air-conditioning control in consideration of energy saving while maintaining comfort of an office. For example, there is also a case where, when a timing to move to a store is controlled so as not to cause congestion in the store in consideration of physical conditions of individuals by referring to biological data thereof, congestion in an elevator is also considered at the same time. Further, for example, there is also a case where purchase loss generated due to an error of a demand forecast is reduced by pricing and, in addition, leftover loss is reduced by serving in consideration of physical conditions of individuals. Such control cannot be achieved without considering interaction between the digital twins.

The disclosed technology has been made in view of the above points, and an object thereof is to provide an optimization device, optimization method, and optimization program that optimize building digital twins of individual objects and events and building a model also in consideration of a mutual influence between the digital twins.

### Solution to Problem

A first aspect of the present disclosure is an optimization device for optimizing a digital twin system including at least two digital twins, the optimization device including: an index value acquisition unit that acquires a first index value of a first digital twin in a case where a first parameter is given; a state estimation unit that estimates a state of the first digital twin after the first parameter is given; a state acquisition unit that acquires the state of the first digital twin, a second index value of a second digital twin obtained in a case where the first parameter is given, and a state of the second digital twin; and an optimization unit that optimizes the first index value and the second index value.

A second aspect of the present disclosure is an optimization method for optimizing a digital twin system including at least two digital twins, in which a computer acquires a first index value of a first digital twin in a case where a first parameter is given, estimates a state of the first digital twin after the first parameter is given, acquires the state of the first digital twin, a second index value of a second digital twin obtained in a case where the first parameter is given, and a state of the second digital twin, and optimizes the first index value and the second index value.

A third aspect of the present disclosure is an optimization program for optimizing a digital twin system including at least two digital twins, the optimization program causing a computer to execute acquiring a first index value of a first digital twin in a case where a first parameter is given, estimating a state of the first digital twin after the first parameter is given, acquiring the state of the first digital twin, a second index value of a second digital twin obtained in a case where the first parameter is given, and a state of the second digital twin, and optimizing the first index value and the second index value.

### Advantageous Effects of Invention

According to the disclosed technology, it is possible to provide an optimization device, optimization method, and optimization program that optimize building digital twins of individual objects and events and building a model also in consideration of a mutual influence between the digital twins.

### BRIEF DESCRIPTION OF DRAWINGS

FIG. 1 illustrates an overview of an embodiment.

FIG. 2 illustrates an example of a correspondence between a virtual space and a real space and values provided in the real space, which are assumed in an embodiment.

FIG. 3 illustrates a schematic configuration example of an embodiment.

FIG. 4 is a block diagram illustrating a hardware configuration of an optimization device.

FIG. 5 is a block diagram illustrating an example of a functional configuration of an optimization device.

FIG. 6 is a flowchart illustrating a flow of optimization processing performed by an optimization device.

FIG. 7 illustrates an example where an appropriate meal is suggested by acquiring information regarding a health condition of a user.

FIG. 8 illustrates an example where a health digital twin of a user, a store digital twin, and a district operation management digital twin are combined.

FIG. 9 illustrates an example where a health digital twin of a user, a store digital twin, and a district operation management digital twin are combined.

FIG. 10 illustrates an example of air-conditioning control.

FIG. 11 illustrates an example where a health digital twin of a user and a district operation management digital twin are combined.

FIG. 12 illustrates exemplary indices of a personal service DT.

FIG. 13 illustrates exemplary indices of a district management DT.

FIG. 14 illustrates exemplary indices of a store operation DT.

FIG. 15 illustrates exemplary indices of a food loss DT.

FIG. 16 illustrates exemplary indices of a mobility DT.

FIG. 17 illustrates exemplary indices of a tenant operation DT.

FIG. 18 illustrates a model example of a DTC district in an urban DTC platform.

FIG. 19 illustrates an overview of an application for store operation provided by a service provider.

FIG. 20 illustrates a specific example of an application for store operation.

FIG. 21 is an explanatory diagram illustrating an example of a relationship between functions in a store operation optimization technology.

FIG. 22 is an explanatory diagram illustrating an example of a relationship between functions in a supply-and-demand optimization/pricing technology.

FIG. 23 is an explanatory diagram illustrating an example of a relationship between functions in a serving size optimization technology.

FIG. 24 illustrates an overview of a mobility application provided by a service provider.

FIG. 25 illustrates a specific example of a mobility application.

FIG. 26 is an explanatory diagram illustrating an example of a relationship between functions in an intra district movement mobility optimization technology.

FIG. 27 illustrates an overview of a health care application provided by a service provider.

FIG. 28 illustrates a specific example of a health care application.

FIG. 29 is an explanatory diagram illustrating an example of a relationship between functions in a behavior recommendation technology.

FIG. 30 illustrates an overview of an environment optimization application provided by a service provider.

FIG. 31 illustrates a specific example of an environment optimization application.

FIG. 32 is an explanatory diagram illustrating an example of a relationship between functions in an environment optimization technology.

FIG. 33 illustrates an overview of a schedule management application provided by a service provider.

FIG. 34 illustrates a specific example of a schedule management application.

FIG. 35 illustrates an overview of a tenant operation application provided by a service provider.

FIG. 36 illustrates a specific example of a tenant operation application.

FIG. 37 illustrates an example of linking of digital twins.

FIG. 38 is an explanatory diagram illustrating an example of a relationship between functions in a district behavior recommendation technology.

FIG. 39 illustrates another example of linking of digital twins.

FIG. 40 illustrates another example of linking of digital twins.

FIG. 41 illustrates another example of linking of digital twins.

FIG. 42 illustrates another example of linking of digital twins.

### DESCRIPTION OF EMBODIMENTS

Hereinafter, examples of an embodiment of the disclosed technology will be described with reference to the drawings. In the drawings, the same or equivalent components and portions are denoted by the same reference signs. Further, dimensional ratios in the drawings are exaggerated for convenience of description and thus may be different from actual ratios.

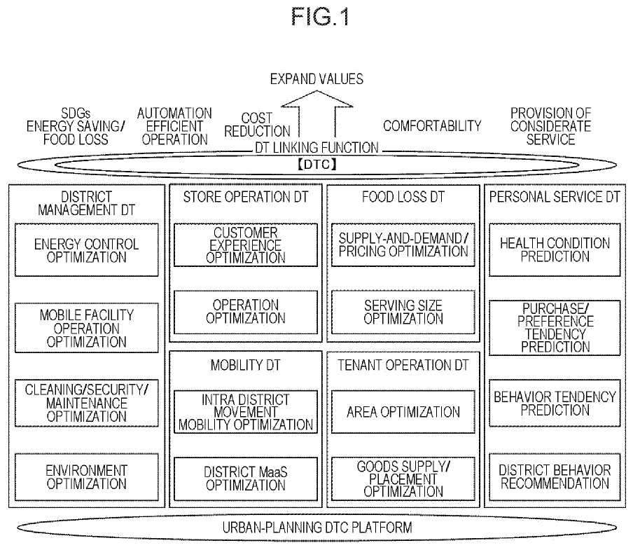

First, an overview of an embodiment of the disclosed technology will be described. FIG. 1 illustrates an overview of the present embodiment.

It is assumed that an optimization device 10 according to the present embodiment is used in an urban-planning digital twin computing (DTC) platform that links a plurality of digital twins to expand values to be provided. In the present embodiment, digital twin computing aiming at expanding the values by linking six digital twins illustrated in FIG. 1 is assumed. By linking the six digital twins, the following values are provided: efficient operation by automation, achievement of SDGs (energy saving and reduction of food loss), cost reduction, comfortability, and provision of a considerate service for a user. In the following description, a virtual area built by the urban DTC platform will be simply referred to as “district”. Note that digital twins to be linked are merely examples, and more digital twins may need to be linked or only some of presented digital twins may be linked depending on a purpose.

For example, as illustrated in FIG. 1, a district management DT is a digital twin that performs energy control optimization, mobile facility operation optimization, cleaning/security/maintenance optimization, and environment optimization. The energy control optimization is, for example, to optimize energy control by predicting a human activity and automatically controlling air conditioning in accordance with the predicted human activity. The mobile facility operation optimization is, for example, to perform optimization by predicting movement of a person in several minutes to efficiently operate an elevator. The cleaning/security/maintenance optimization is, for example, to predict a use state by a person and optimize work of a cleaning robot in accordance with the predicted use state or to perform optimization by setting an optimal placement or optimal path of a security robot. The environment optimization is, for example, to optimize an environment by adjusting a lighting, humidity, temperature, wallpaper, smell, sound, or the like in accordance with a health condition, behavior prediction, or schedule of a person.

For example, as illustrated in FIG. 1, a store operation DT is a digital twin for achieving customer experience optimization and operation optimization. The customer experience optimization is, for example, to perform optimization by estimating a degree of congestion and determining optimal customer distribution on the basis of a demand forecast and a human behavior prediction. The operation optimization is, for example, to optimize store layout, assignment of people, inventory, and procurement on the basis of the demand forecast.

For example, as illustrated in FIG. 1, a mobility DT is a digital twin for achieving intra district movement mobility optimization and district mobility as a service (MaaS) optimization. The intra district movement mobility optimization is, for example, to optimize movement in the district by determining an optimal placement and an optimal path according to a behavior prediction and a use order of a user. The district MaaS optimization is, for example, to optimize movement of people who visit the district by determining optimal vehicle allocation that reflects behavior predictions of individuals and a traffic state prediction.

For example, as illustrated in FIG. 1, a food loss DT is a digital twin for achieving supply-and-demand/pricing optimization and serving size optimization. In the supply-and-demand/pricing optimization is, for example, to optimize an amount of purchase on the basis of a demand forecast, to optimize supply and demand of ingredients by sharing an excess ingredient and controlling pricing, or to optimize a price setting. The serving size optimization is, for example, to optimize a serving size by extracting a factor from profiles of individuals, an external factor, and menu details.

For example, as illustrated in FIG. 1, a tenant operation DT is a digital twin for achieving area optimization and goods supply/placement optimization. The area optimization is, for example, to optimally allocate a district area for each period of time, thereby optimizing utilization efficiency of the area. The goods supply/placement optimization is, for example, to optimize supply and placement of goods on the basis of a demand forecast and automatic compensation of goods in the area including behaviors of individuals.

For example, as illustrated in FIG. 1, a personal service DT is a digital twin for achieving health condition prediction, purchase/thinking tendency prediction, behavior tendency prediction, and district behavior recommendation. The health condition prediction is, for example, to estimate a health condition of the user on the basis of vital signs of the user, such as a body temperature, heart rate pulse, and blood pressure, and recommend the user's behavior or meal to the user. A change in the health condition is also predicted based on the recommendation result. The purchase/thinking tendency prediction is, for example, to estimate a preference of the user on the basis of a purchase history or the like of the user, perform a demand forecast that reflects the preference of the user, and recommend purchase to the user. The behavior tendency prediction is, for example, to predict behavior of each individual in the district and recommend proactive behavior to the user. The district behavior recommendation is to reflect prediction of the health, preference, and behavior of the user and recommend behavior to the user, thereby supporting behavior of the user.

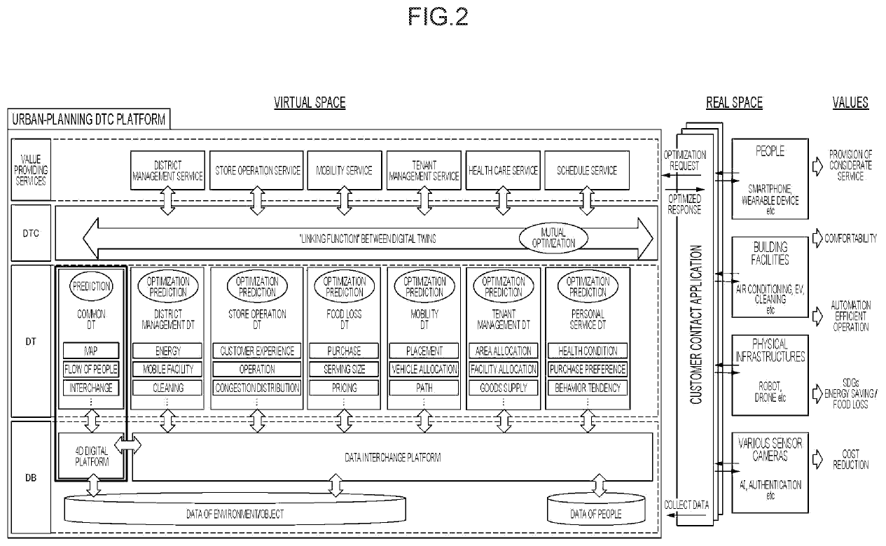

FIG. 2 illustrates an example of a correspondence between a virtual space and a real space and values provided in the real space, which are assumed in the present embodiment. In FIG. 2, the urban DTC platform is exemplified as the virtual space. Information collected from the real space is registered in a database (DB) of the virtual space, and various digital twins are built in the virtual space by using the information registered in the database. Then, various services are provided by linking two or more digital twins in the virtual space. An optimization request of the digital twins is issued from the real space through a customer contact application, and an optimized response is output from the virtual space to the real space through the customer contact application.

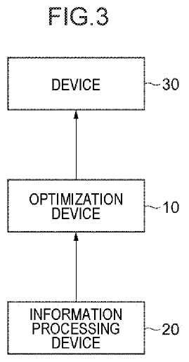

FIG. 3 illustrates a schematic configuration example of the present embodiment. FIG. 3 illustrates the optimization device 10 that optimizes a digital twin system, an information processing device 20 that provides various kinds of data for the optimization device 10, and a device 30 that operates based on the digital twin system optimized by the optimization device 10.

The optimization device 10 optimizes the digital twin system including at least two digital twins. Each digital twin can be built based on, for example, data provided from the information processing device 20. The optimization device 10 uses data provided from the information processing device 20 when optimizing the digital twin system. The information processing device 20 provides, for example, sensing data. In a case where the optimization device 10 controls the device 30 existing in the real world as a result of optimization of the digital twin system, the optimization device outputs information for controlling the device 30.

The digital twin system may be built in the optimization device 10 or may be built in another device different from the optimization device 10.

The information processing device 20 provides information for the optimization device 10 and includes, for example, various sensors for sensing states. Examples of the information processing device 20 include a smartphone, a tablet terminal, and a wearable terminal. Examples of the sensors included in the information processing device 20 include biological information sensors for acquiring information regarding human vital signs, such as a body temperature, heart rate pulse, and blood pressure, and a sensor for acquiring information regarding a device, apparatus, or the like used by a person. Examples of the sensors included in the information processing device 20 further include sensors mounted together in a facility such as air conditioning or an EV installed in a building facility, a sensor provided in a physical infrastructure such as a robot or drone, and a camera and sensor installed in a building, as illustrated in FIG. 2.

The device 30 includes various devices existing in the real world. The device 30 executes operation on the basis of information output from the digital twin system optimized by the optimization device 10. The device 30 also includes a digital signage, smartphone, PC, and the like that present information to people and includes all things that affect people, things, and environments in the real world.

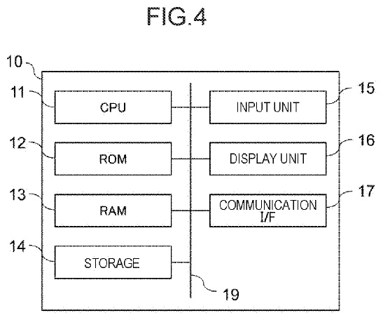

FIG. 4 is a block diagram illustrating a hardware configuration of the optimization device 10.

As illustrated in FIG. 4, the optimization device 10 includes a central processing unit (CPU) 11, a read only memory (ROM) 12, a random access memory (RAM) 13, a storage 14, an input unit 15, a display unit 16, and a communication interface (I/F) 17. The components are communicably connected to each other via a bus 19.

The CPU 11 is a central processing unit, executes various programs, and controls each unit. That is, the CPU 11 reads programs from the ROM 12 or the storage 14 and executes the programs by using the RAM 13 as a work area. The CPU 11 controls each component described above and performs various kinds of operation processing according to the programs stored in the ROM 12 or the storage 14. In the present embodiment, the ROM 12 or the storage 14 stores an optimization program for optimizing the digital twin system. Further, a plurality of digital twins may be built in the storage 14.

The ROM 12 stores various programs and various kinds of data. The RAM 13 temporarily stores programs or data as a work area. The storage 14 includes a storage device such as a hard disk drive (HDD) or solid state drive (SSD) and stores various programs including an operating system and various kinds of data.

The input unit 15 includes a pointing device such as a mouse and a keyboard and is used to perform various inputs.

The display unit 16 is, for example, a liquid crystal display and displays various kinds of information. The display unit 16 may function as the input unit 15 by adopting a touchscreen system.

The communication interface 17 is an interface for communicating with another device. For the communication, for example, a wired communication standard such as Ethernet (registered trademark) or FDDI or a wireless communication standard such as 4G, 5G, or Wi-Fi (registered trademark) is used.

Next, each functional configuration of the optimization device 10 will be described.

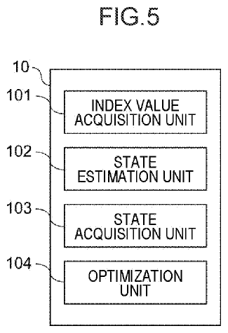

FIG. 5 is a block diagram illustrating an example of the functional configuration of the optimization device 10.

As illustrated in FIG. 5, the optimization device 10 includes an index value acquisition unit 101, a state estimation unit 102, a state acquisition unit 103, and an optimization unit 104 as functional configurations. Each functional configuration is achieved by the CPU 11 reading the optimization program stored in the ROM 12 or the storage 14, loading the optimization program in the RAM 13, and executing the optimization program.

Here, a technology for simultaneously optimizing a degree of comfort that is one of indices of a digital twin of an individual person and a degree of customer satisfaction that is one of indices of a digital twin of an arbitrary store will be described as an example of a technology for simultaneously optimizing a plurality of digital twins having interaction.

First, an overview will be qualitatively described. The degree of comfort of the digital twin of the individual person changes, for example, depending not only on eating food that suits the person's taste but also on a state of a place where the person eats food. The degree of customer satisfaction of the digital twin of the arbitrary store changes depending not only on a product to be provided and a facility of the store but also on the degree of congestion and a product provision time that changes with congestion. The degree of congestion changes depending on behavior of the digital twin of the individual person. That is, the degree of comfort and the degree of customer satisfaction can be simultaneously optimized by interfering with the digital twin of the individual person at an arbitrary time and changing a time of arrival at the digital twin of the arbitrary store to an appropriate time. In other words, behavior prediction in the future from a start point on a time axis (e.g. any one of or a combination of a time, place, behavior previously before, schedule, and health condition) is performed based on behavior occurring at the start point serving as an arbitrary trigger. Then, the degree of comfort and the degree of customer satisfaction can be simultaneously optimized by performing the behavior prediction, then predicting in advance a state that will occur in involved digital twins (e.g. in the digital twin of the store and a district management digital twin) in the future, predicting states of the involved digital twins while changing the starting point, setting the highest index values as an optimal state, and leading the digital twin of the individual person into optimal behavior. The above-described interference may be, for example, recommendation of a time at which the digital twin of the individual person should start going out, provision of external information for delaying the time at which the digital twin of the person starts going out by an appropriate amount of time, or an incentive given in a case where the digital twin of the person follows the recommendation.

Here, the digital twin of the individual person may be a single digital twin or a plurality of digital twins. The digital twin of the individual person and the digital twin of the arbitrary store may be other kinds of digital twins as long as the digital twins have interaction. Although the degree of comfort and the degree of customer satisfaction have been described as indices to be optimized, other indices may be used as indices to be optimized. Instead of the arbitrary time, an arbitrary place or arbitrary time and place may be used. Further, the health condition, schedule, time, place, or behavior immediately before may be used. Not only two kinds of digital twins, that is, the individual person and the store, but also three or more kinds of digital twins may be used.

Hereinafter, in the present embodiment, the digital twin of the individual person will also be referred to as “first digital twin”, the digital twin of the arbitrary store will also be referred to as “second digital twin”, the degree of comfort will also referred to as “first index value”, the degree of customer satisfaction will also be referred to as “second index value”, the arbitrary time will also be referred to as “first parameter”, and the interference will also be referred to as “second parameter”.

In a case where the first parameter is given, the index value acquisition unit 101 acquires the first index value of the first digital twin built in a predetermined place. The first digital twin may be built based on, for example, data provided from the information processing device 20.

The state estimation unit 102 estimates a state of the first digital twin after the first parameter is given. The state of the first digital twin may be information such as an action taken by the digital twin of the individual person or a time or property related to the action.

The state acquisition unit 103 acquires the state of the first digital twin, the second index value of the second digital twin, and a state of the second digital twin. The second digital twin may be built based on, for example, data provided from the information processing device 20. The state acquisition unit 103 may further acquire the second index value of the second digital twin and the state of the second digital twin when the second parameter is given to the first digital twin.

The optimization unit 104 optimizes the first index value acquired by the index value acquisition unit 101 and the second index value acquired by the state acquisition unit 103. The first index value may be the degree of comfort of the first digital twin, and the second index value may be the degree of customer satisfaction of the second digital twin. The optimization unit 104 may further give the second parameter for changing the state of the first digital twin to the first digital twin in order to optimize the first index value and the second index value. In a case where the first digital twin is a digital twin of one person, the second parameter may be a time at which the first digital twin should start moving. Alternatively, the second parameter may be a parameter that can change the time at which the first digital twin should start moving. The second parameter only needs to be set such that the first index value and the second index value that change as a result of giving the second parameter become optimal values. For example, the second parameter may be set to cause a maximum sum of the first index value and the second index value.

The optimization device 10 has the above configuration and can therefore optimize building digital twins of individual objects or events and building a model also in consideration of a mutual influence between the digital twins.

Next, effects of the optimization device 10 will be described.

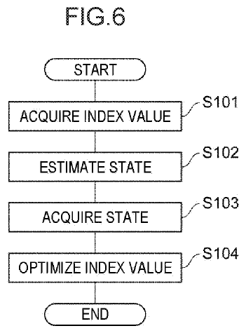

FIG. 6 is a flowchart illustrating a flow of optimization processing performed by the optimization device 10. The optimization processing is performed by the CPU 11 reading the optimization processing program from the ROM 12 or the storage 14, loading the optimization processing program in the RAM 13, and executing the optimization processing program.

In step S101, in a case where the first parameter is given, the CPU 11 serving as the index value acquisition unit 101 acquires the first index value of the first digital twin. The first digital twin may be a digital twin of one person.

After step S101, in step S102, the CPU 11 serving as the state estimation unit 102 estimates a state of the first digital twin after the first parameter is given. In a case where the first digital twin is a digital twin of one person, the state of the first digital twin may be an action taken by the person.

After step S102, in step S103, the CPU 11 serving as the state acquisition unit 103 acquires the state of the first digital twin, the second index value of the second digital twin built in a predetermined place and different from the first digital twin, and a state of the second digital twin, the second index value and the state of the second digital twin being obtained in a case where the same parameter as the parameter given to the first digital twin is given. The second digital twin may be a digital twin of an arbitrary store. In a case where the second digital twin is a digital twin of an arbitrary store, the state of the second digital twin may include at least the degree of congestion of the store.

After step S103, in step S104, the CPU 11 serving as the optimization unit 104 optimizes the first index value acquired in step S101 and the second index value acquired in step S103. The optimization unit 104 may further give the second parameter for changing the state of the first digital twin to the first digital twin. In a case where the first digital twin is a digital twin of one person, the second parameter may be a time at which the first digital twin should start moving.

The optimization device 10 executes the above series of processing and can therefore optimize building digital twins of individual objects or events and building a model also in consideration of a mutual influence between the digital twins.

Next, the effects of the optimization device 10 will be described with reference to examples.

### First Example

In a first example, an effect of the optimization device 10 obtained in a case where health digital twins of users, a store digital twin, and a district operation management digital twin are combined will be described.

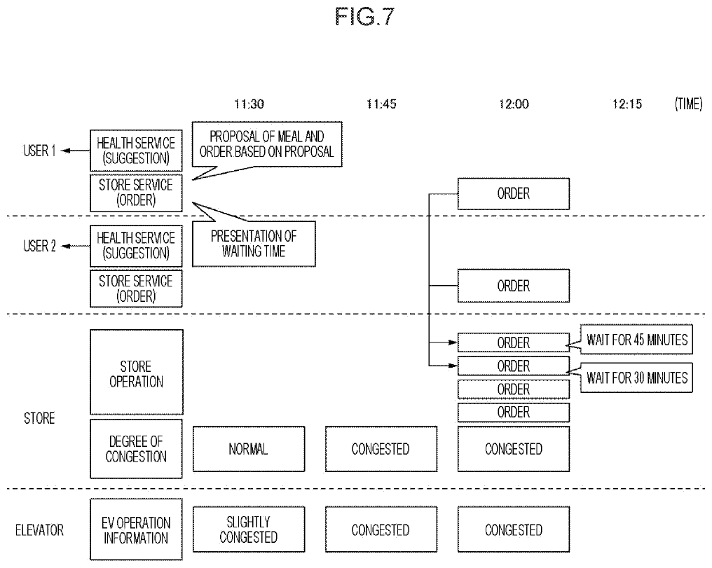

FIG. 7 illustrates an example where an appropriate meal is suggested by predicting information regarding a health condition of each user. By predicting the information regarding the health condition of each user, it is possible to suggest an appropriate meal timing or present a waiting time. However, a timing to visit the store and a timing of order depend on the users, and thus orders may be concentrated and stacked. In the example of FIG. 7, when a plurality of users place orders at the store at 12:00, the orders are stacked, and the waiting time increases. Further, an elevator is congested with the users of the store.

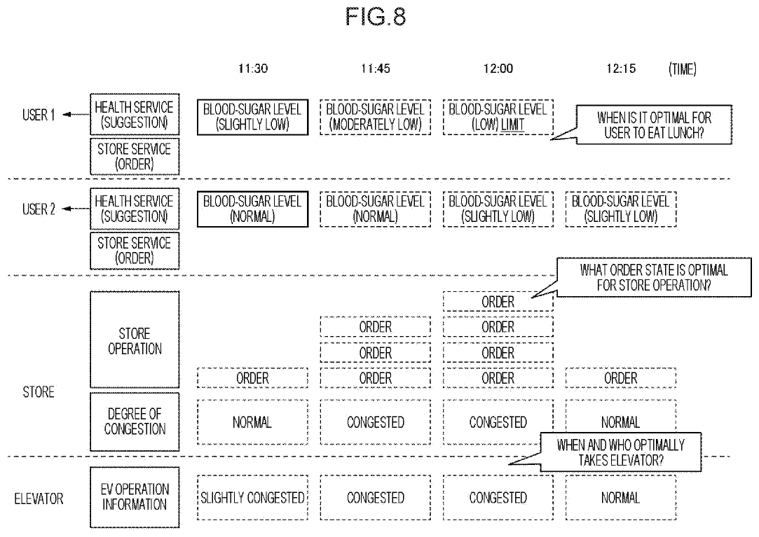

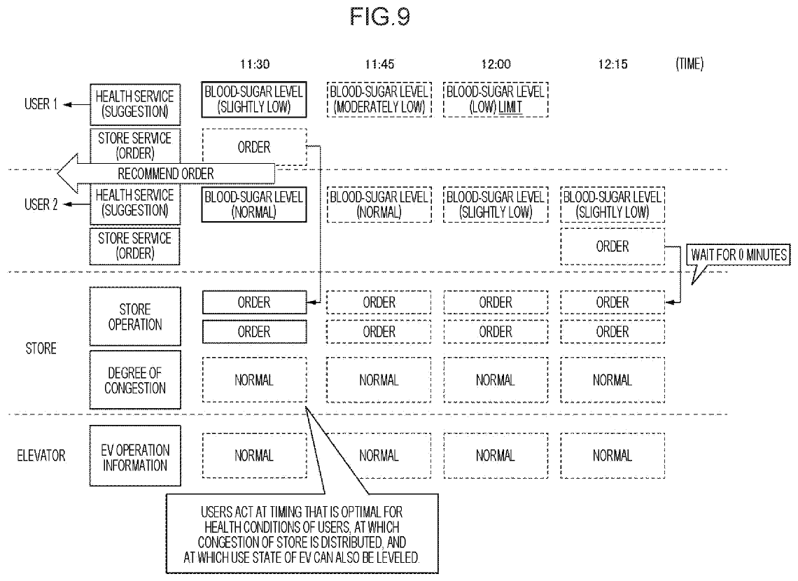

FIGS. 8 and 9 illustrate examples where the health digital twins of the users, the store digital twin, and the district operation management digital twin are combined. The optimization device 10 predicts in advance when it is appropriate to eat lunch on the basis of the health digital twins of the users. The optimization device 10 also predicts in advance what order state is optimal for store operation on the basis of the store digital twin. The optimization device 10 also predicts in advance when and who optimally takes the elevator on the basis of the district operation management digital twin.

The optimization device 10 makes a recommendation for causing the digital twins of the users to act at a timing that is optimal for the health conditions of the users, at which the congestion of the store is distributed, and at which a use state of the elevator can also be leveled. Therefore, as illustrated in FIG. 9, the optimization device 10 can create a state in which there is no waiting time, regardless of which user places an order. Further, as illustrated in FIG. 9, it is also possible to create a state in which the elevator is not congested with the users of the store.

In the first example, the optimization device 10 also models a mutual influence between the digital twins as described above. First, there are digital twins of a person, store, and elevator. Considering only the digital twin of the person, an action of going to the store is taken in consideration of a health condition, a degree of hunger, and preference.

The action of the digital twin of the person affects getting on and off the digital twin of the elevator, energy use, a revenue of the digital twin of the store, the degree of congestion, and an inventory. As a result of the action taken by the digital twin of the person, the degree of congestion of the store increases, for example, and thus the digital twin of the person may have to wait in the store, or a health condition of a digital twin of another person existing in the store may become worse.

In such a case, the digital twin of the person can satisfy his/her degree of hunger or preference, but an index (e.g. the degree of customer satisfaction) of the another digital twin decreases. Thus, this case is not total optimization. Therefore, in order to perform total optimization, the optimization device 10 makes a recommendation to the digital twin of the person so as to change an action of the digital twin of the person to perform total optimization.

For example, in a case where the index value of the digital twin of the person decreases when the degree of congestion is high or the waiting time in the store is long, the optimization device 10 recommends a departure time that achieves total optimization as a result of the action. In a case where the index value of the digital twin of the person does not decrease even when the degree of congestion is high or the waiting time in the store is long, the optimization device 10 recommends a store different from the store described above, thereby controlling the action of the digital twin of the person.

In the first example, the digital twins of the person and the store have been exemplified. However, the optimization device 10 may further consider a digital twin of an elevator that the person uses on the way to the store and optimize indices of three digital twins of the person, the elevator, and the store. The optimization device 10 can also feed back this recommendation to the real space and make a recommendation to the person who is a base of the digital twin of the person.

### Second Example

In a second example, an effect of the optimization device 10 obtained in a case where the health digital twins of the users and the district operation management digital twin are combined will be described.

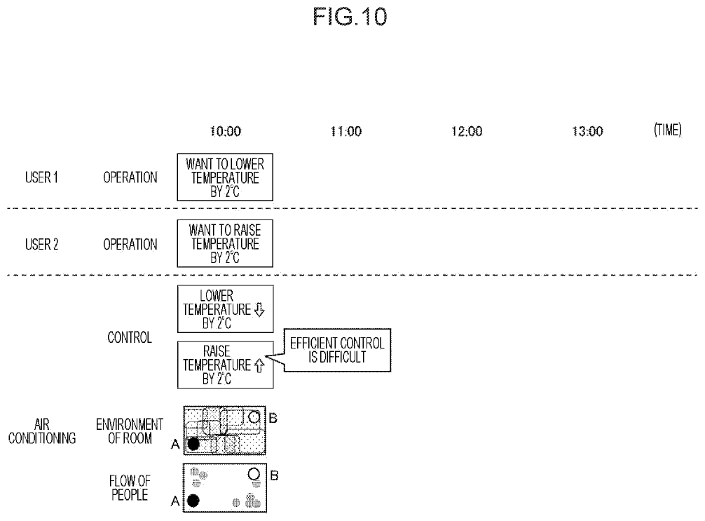

FIG. 10 illustrates an example of air-conditioning control. In the example of the air-conditioning control in FIG. 10, each user has authority to change a room temperature of a room. There are individual differences in thermal sensation between people. Even at the same room temperature, a certain user feels hot, and another user feels cold. Therefore, in a case where a plurality of users having different thermal sensations are in the same room, a certain user may desire to lower the room temperature by two degrees, and another user may desire to raise the room temperature by two degrees. However, such air-conditioning control is difficult.

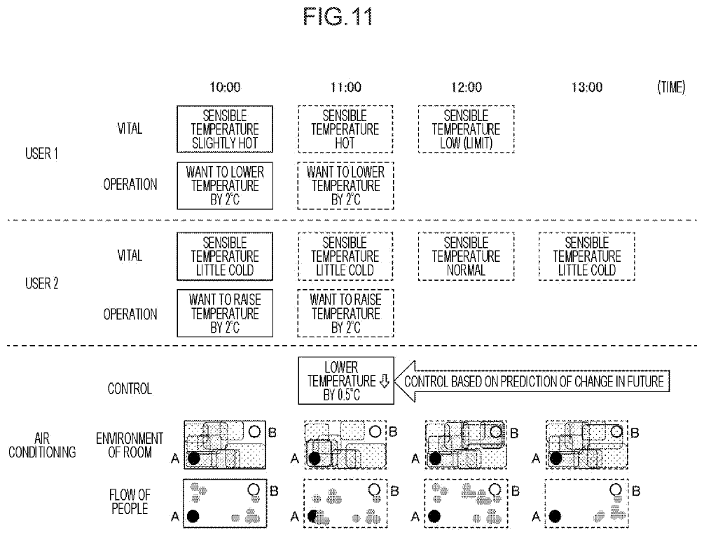

FIG. 11 illustrates an example where the health digital twins of the users and the district operation management digital twin are combined. The optimization device 10 predicts in advance an environment of the room, a flow of people in the room, and a state of an individual person, thereby predicting efficient control for both the individual person and the district.

The optimization device 10 optimizes the index values of the digital twins as described above. Categories of the indices are based on financial indices and non-financial indices. The financial indices and the non-financial indices can be, for example, indices disclosed in “Industry-classified analysis of financial indices and non-financial indices” (see https://www.jstage.jst.go.jp/article/jcar/28/2/28 KJ00008538768/_pdf). The optimization device 10 according to the present embodiment uses three indices, i.e., “profitability”, “degree of customer satisfaction”, and “environmental impact” as optimization indices. An index of the degree of customer satisfaction can be, for example, a customer experience (CX; customer experience value) index (see https://www.nri.com/-/media/Corporate/jp/Files/PDF/knowledge/report/cc/mediaforum/2019/forum283.pdf?la=j a-JP&hash=8B5A4D92CA1006ABD493876E57911B136928DF00) or the Japanese customer satisfaction index (JCSI) (see https://www.meti.go.jp/committee/kenkyukai/sansei/chiikikigyo_hyoka/pdf/003_s02_00.pdf).

Hereinafter, indices optimized for each digital twin by the optimization device 10 will be exemplified.

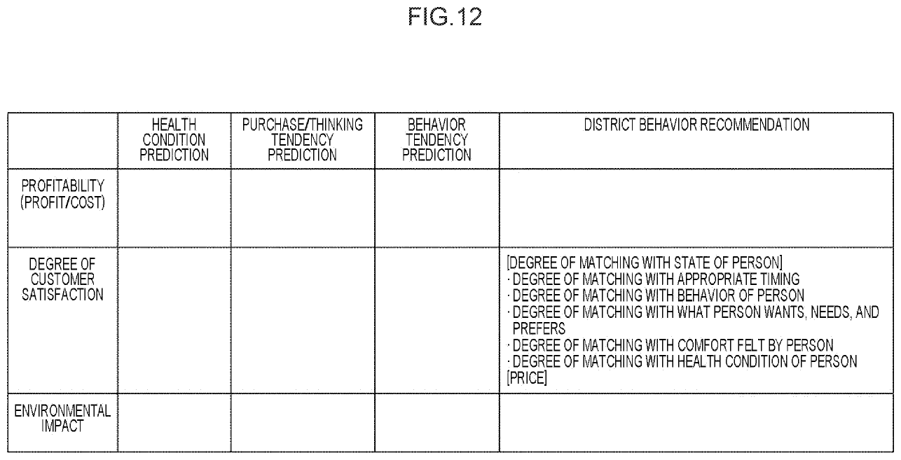

FIG. 12 illustrates exemplary indices of the personal service DT. In the present embodiment, the indices in FIG. 12 are used in the district behavior recommendation of the personal service DT. In the personal service DT, a degree of matching with a state of a person and a price are used as indices of the degree of customer satisfaction. Examples of the degree of matching with the state of the person include a degree of matching with an appropriate timing, a degree of matching with behavior of the person, a degree of matching with what the person wants, needs, and prefers, a degree of matching with comfort felt by the person, and a degree of matching with the health condition of the person, but are not limited thereto.

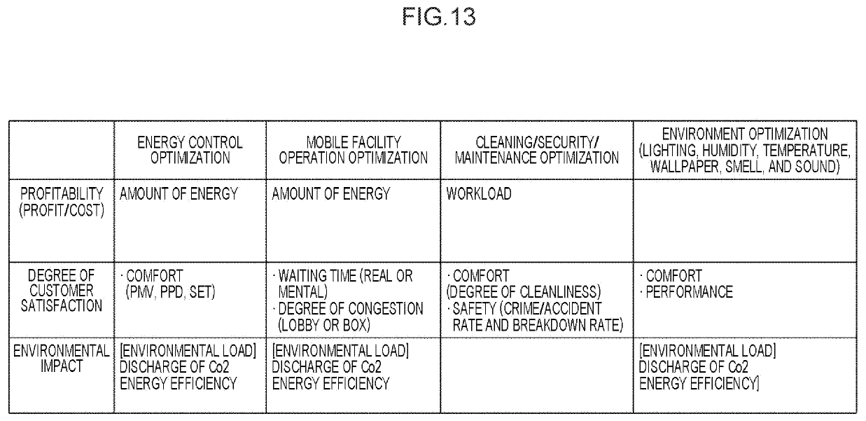

FIG. 13 illustrates exemplary indices of the district management DT. In the present embodiment, the indices in FIG. 13 are used in the energy control optimization, mobile facility operation optimization, cleaning/security/maintenance optimization, and environment optimization of the district management DT. Here, an index of energy is shown in both the energy control optimization and the mobile facility operation optimization. Although much energy is used to optimize operation of a mobile facility, the energy is not always used optimally in that case. Meanwhile, it is not always possible to optimize the operation of the mobile facility in a case where the energy is optimally used. Therefore, in the district management DT, an energy use amount is derived to be optimal for both. Note that the indices of the district management DT are not limited to those illustrated in FIG. 13.

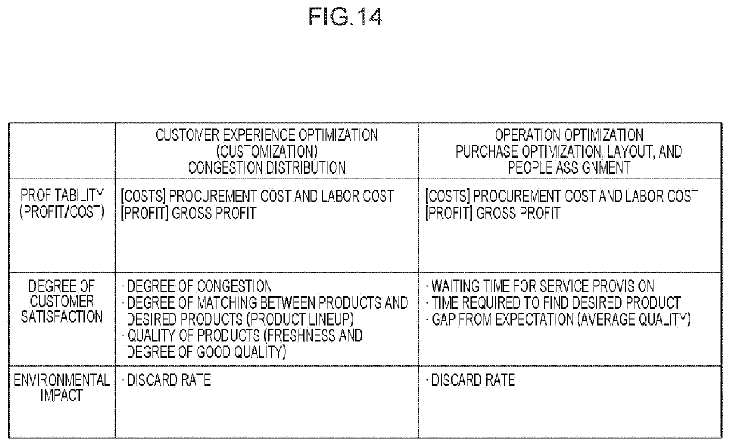

FIG. 14 illustrates exemplary indices of the store operation DT. In the present embodiment, the indices in FIG. 14 are used in the customer experience optimization and the operation optimization of the store operation DT. Also among the indices of the store operation DT, some indices are common to the optimizations. Therefore, in the store operation DT, the indices are derived to be optimal in each optimization. Note that the indices of the store operation DT are not limited to those illustrated in FIG. 14.

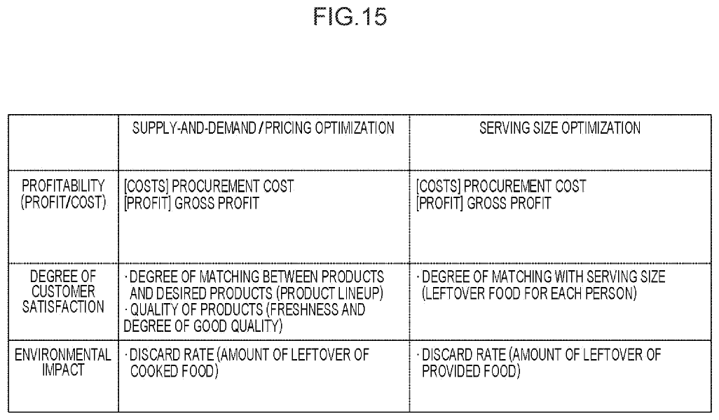

FIG. 15 illustrates exemplary indices of the food loss DT. In the present embodiment, the indices in FIG. 15 are used in the supply-and-demand/pricing optimization and serving size optimization of the food loss DT. Note that the indices of the food loss DT are not limited to those illustrated in FIG. 15.

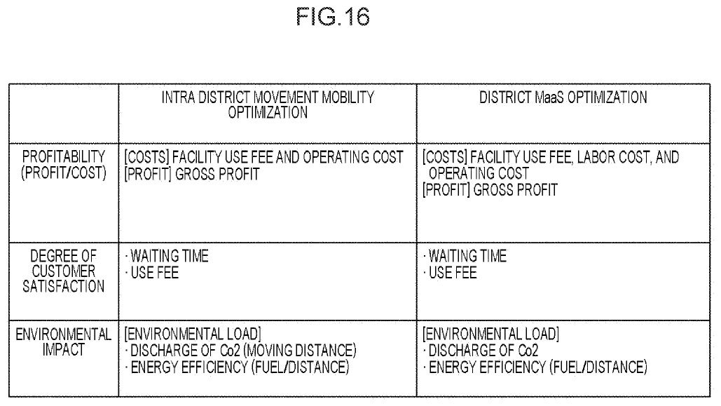

FIG. 16 illustrates exemplary indices of the mobility DT. In the present embodiment, the indices in FIG. 16 are used in the intra district movement mobility optimization and the district MaaS optimization of the mobility DT. Note that the indices of the mobility DT are not limited to those illustrated in FIG. 16.

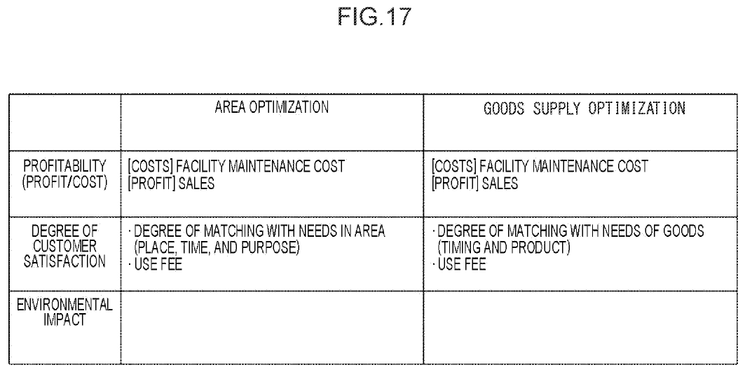

FIG. 17 illustrates exemplary indices of the tenant operation DT. In the present embodiment, the indices in FIG. 17 are used in the area optimization and goods supply optimization of the tenant operation DT. Note that the indices of the tenant operation DT are not limited to those illustrated in FIG. 17.

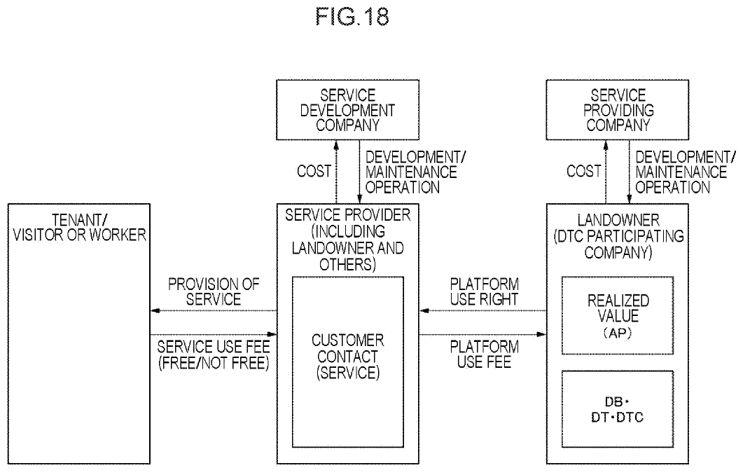

FIG. 18 illustrates a model example of a DTC district in the urban DTC platform. A landowner participating in the DTC (DTC participating company) pays a cost to a service providing company to receive provision of development and maintenance operation of a service from the service providing company. The landowner has digital twin computing that builds digital twins on the basis of information stored in the database and links the plurality of digital twins. When receiving payment of a platform use fee from the service provider, the landowner gives a platform use right for using the urban DTC platform to the service provider. Note that the landowner (DTC participating company) may be a business operator or local government that operates the district.

The service provider pays a cost to a service development company to receive provision of development and maintenance operation of a service from the service providing company.

When the service provider receives payment of a service use fee from a tenant, visitor, or worker, the service provider provides a service for the tenant, visitor, or worker. In the example in FIG. 18, the service provided by the service provider is the customer contact application. The service use fee paid by the visitor or worker may be free. The service provider may be the landowner participating in the DTC.

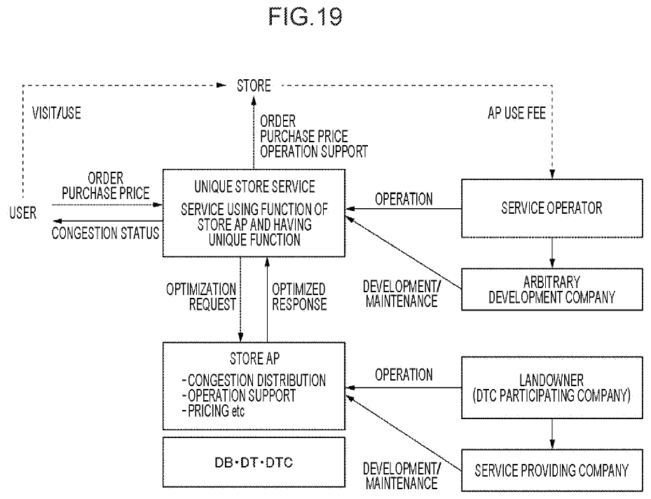

FIG. 19 illustrates an overview of an application for store operation (store AP) provided by the service provider. The application for store operation provides a function of optimizing distribution of congestion in a store, operation support in the store, pricing of products, and the like.

The landowner participating in the DTC (DTC participating company) operates the application for store operation by paying a cost to the service provider. The application for store operation is developed and maintained by the service provider.

The store that uses the application for store operation pays an application fees to a service operator. The service operator operates a store original service. The store original service uses a function of the application for store operation and has a unique function. The store original service may be developed and maintained by an arbitrary development company.

When using the store, a user receives provision of a congestion status from the store original service. The store original service issues an optimization request to the application for store operation when providing the congestion status. The application for store operation instructs the optimization device 10 to perform optimization processing in response to the request, acquires the index values of the digital twins optimized by the optimization device 10, and returns an optimized response to the store original service.

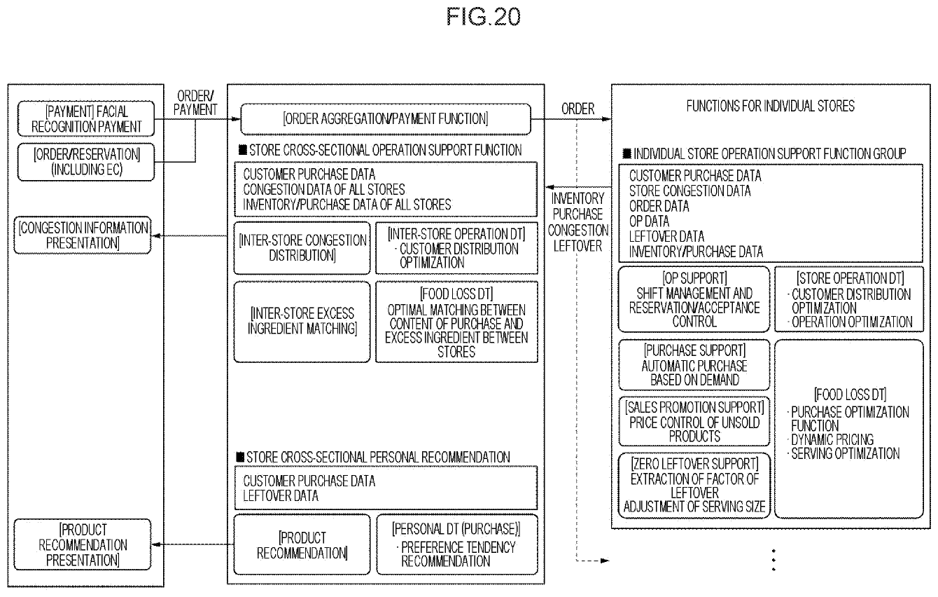

FIG. 20 illustrates a specific example of the application for store operation.

Functions for users of the application for store operation include a payment function, an order/reservation function, a congestion information presentation function, and a product recommendation presentation function. The payment function may be combined with, for example, a face recognition technology or a biometric authentication technology.

All-store cross-sectional functions of the application for store operation include an order aggregation/payment function, an inter-store congestion distribution function, an inter-store excess ingredient matching function, and a product recommendation function. An inter-store operation DT is used when the inter-store congestion distribution function is executed, and the food loss DT is used when the inter-store excess ingredient matching function is executed. The personal service DT is used when the product recommendation function is executed. The inter-store congestion distribution function transmits congestion information to the congestion information presentation function. The product recommendation function transmits recommendation information to the product recommendation presentation function.

Functions for individual stores of the application for store operation include an operation support function, a purchase supporting function, a sales promotion support function, and a zero leftover support function. The store operation DT is used when the operation support function is executed, and the food loss DT is used when the purchase supporting function, the sales promotion support function, and the zero leftover support function are executed.

When the order aggregation/payment function acquires order information output by the order aggregation/payment function, the order aggregation/payment function transmits the order information to a store where the order has been placed. An individual store transmits inventory information, purchase information, congestion information, and leftover information to the all-store cross-sectional functions.

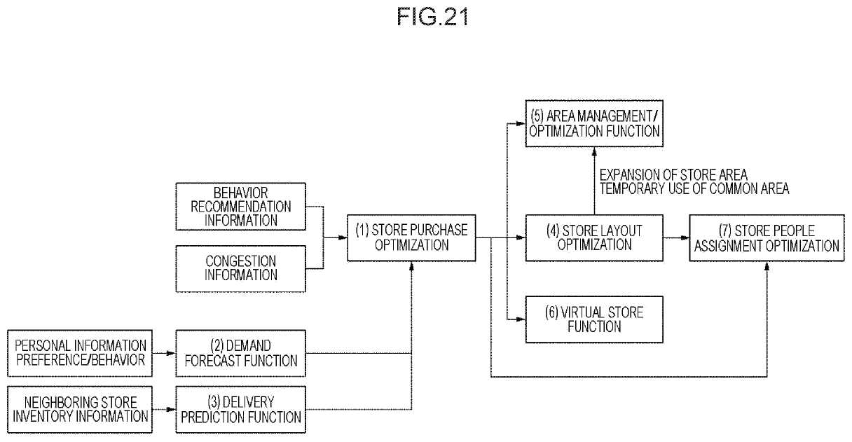

FIG. 21 is an explanatory diagram illustrating an example of a relationship between functions in the store operation optimization technology.

The store operation optimization technology performs an optimal operation of a store on the basis of information regarding the district behavior recommendation obtained in the district behavior recommendation technology.

A store purchase optimization function performs inventory purchase matching with a visiting user on the basis of behavior recommendation information and the congestion information. When performing inventory purchase matching the visiting user, the store purchase optimization function utilizes information regarding a demand forecast function based on personal information (preference and behavior) and a delivery prediction function based on inventory information of a neighboring store in a case where there is no inventory of the product to be purchased.

A store layout optimization function optimizes a layout in the store on the basis of an amount of purchase and variation. In some cases, the store operation optimization technology enables expansion of an area of the store, temporary use of a common area, or the like by using an area management/optimization function.

The store operation optimization technology also utilizes a virtual store function in a case where it is impossible to secure an inventory or there is a behavior recommendation to a store other than existing stores. The store operation optimization technology further utilizes a people assignment optimization function in consideration of the store layout and congestion prediction in order to optimize operation.

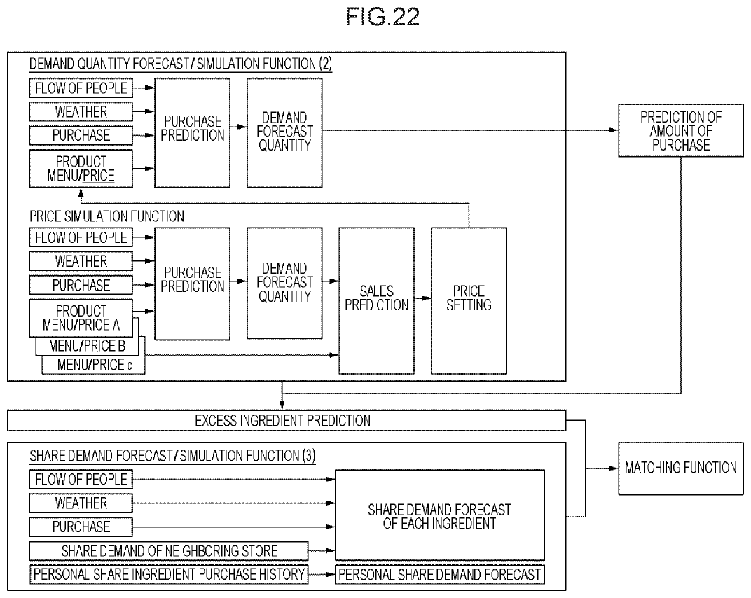

FIG. 22 is an explanatory diagram illustrating an example of a relationship between functions in a supply-and-demand optimization/pricing technology.

The supply-and-demand optimization/pricing technology has a supply and demand optimization function of outputting an amount of purchase based on a demand forecast. The supply-and-demand optimization/pricing technology also has a matching function of determining excess of the amount of purchase in accordance with a change in the demand forecast and matching the excess with a share demand forecast. A demand forecast quantity is obtained by a demand prediction.

A demand quantity forecast function forecasts a demand quantity by performing a macro purchase prediction obtained based on flow-of-people data, weather data, purchase data, and product information (menu and price). The demand quantity forecast function also performs simulation while changing the price and outputs a price setting that maximizes the demand quantity.

A share demand quantity is obtained by a share demand prediction. The share demand forecast function forecasts a share demand quantity of each ingredient on the basis of the flow-of-people data, the weather data, the purchase data, sharing demand data of a neighboring store, and the like. The share demand prediction also forecasts a personal share demand quantity of a person in consideration of personal share ingredient purchase data.

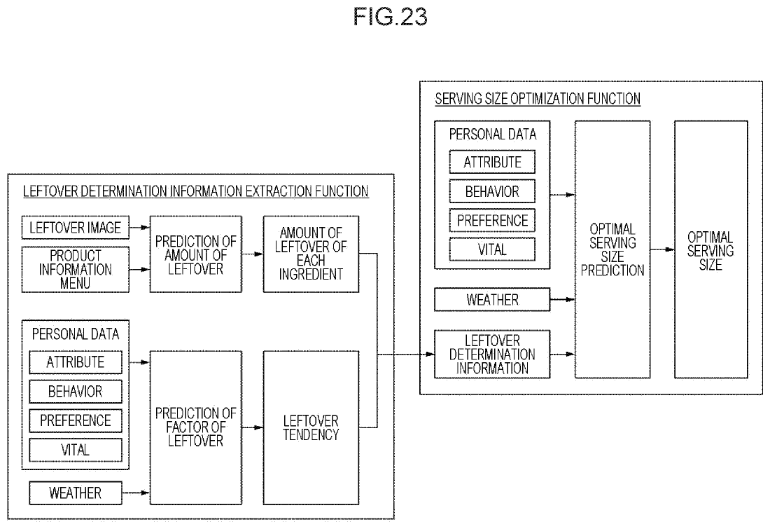

FIG. 23 is an explanatory diagram illustrating an example of a relationship between functions in a serving size optimization technology.

The serving size optimization function outputs an optimal serving size of each menu on the basis of leftover determination information, personal information (attribute, behavior, preference, and vitals), and the weather data. A leftover determination information extraction function determines an amount of leftover for each ingredient on the basis of a leftover image and the product information (menu) and outputs the leftover determination information. When outputting the leftover determination information, the leftover determination information extraction function also determines a factor of leftover in consideration of the personal information (attribute, behavior, preference, and vitals) and the weather data.

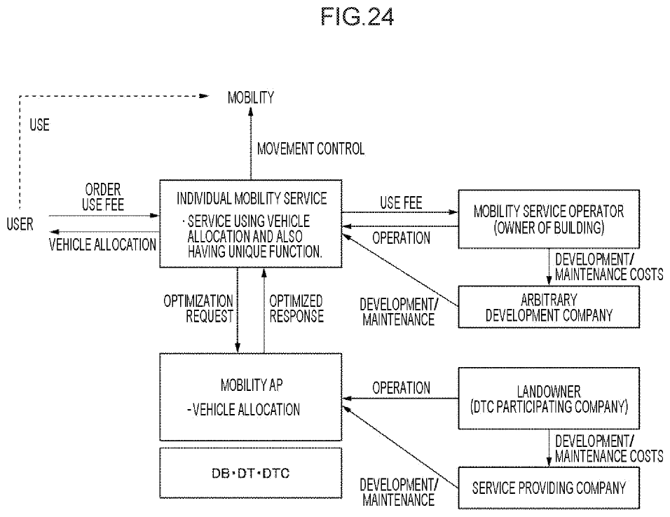

FIG. 24 illustrates an overview of a mobility application (mobility AP) provided by the service provider. The mobility application provides a function of optimizing vehicle allocation and the like.

The landowner participating in the DTC (DTC participating company) operates the mobility application by paying a development cost and a maintenance cost to the service providing company. The mobility application executes a vehicle allocation function. The mobility application is developed and maintained by the service provider.

A business operator who uses the mobility application pays an application fees to a mobility service operator. The mobility service operator operates a mobility service. The mobility service uses a function of the mobility application and has a unique function. The unique service may be developed and maintained by an arbitrary development company.

When the user uses a vehicle, the vehicle is allocated from an individual mobility service. The individual mobility service issues an optimization request to the mobility application when allocating the vehicle to the user. The mobility application instructs the optimization device 10 to perform optimization processing in response to the request, acquires the index values of the digital twins optimized by the optimization device 10, and returns an optimized response to the individual mobility service.

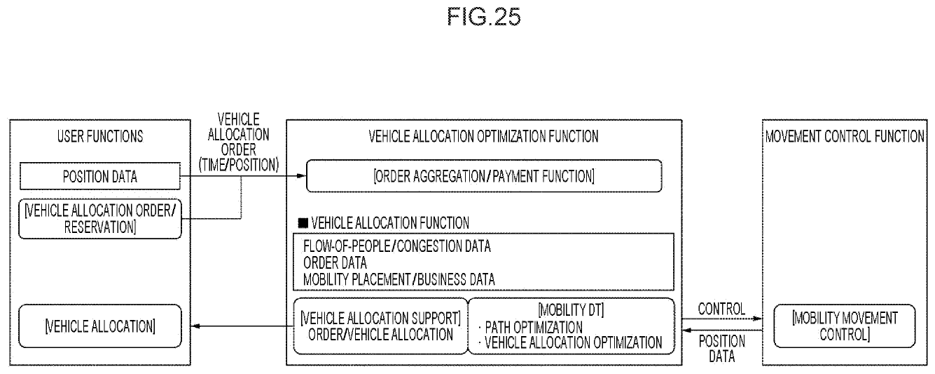

FIG. 25 illustrates a specific example of the mobility application.

Functions for users of the mobility application include a vehicle allocation order/reservation function and a vehicle allocation function.

A vehicle allocation optimization function of the mobility application includes an order aggregation/payment function and a vehicle allocation support function. The mobility DT is used when the vehicle allocation support function is executed.

A movement control function of the mobility application includes a mobility movement control function.

When the order aggregation/payment function acquires order information together with position information of the user output by the vehicle allocation order/reservation function, the vehicle allocation optimization function allocates a vehicle to the user so as to achieve optimal vehicle allocation. When the vehicle allocation optimization function issues a request for control to the movement control function, the mobility movement control function transmits position data to the vehicle allocation optimization function so that appropriate vehicle allocation is achieved.

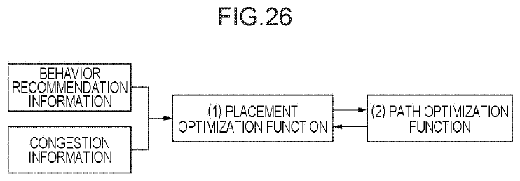

FIG. 26 is an explanatory diagram illustrating an example of a relationship between functions in an intra district movement mobility optimization technology.

The intra district movement mobility optimization technology performs optimal operation of an intra district mobility on the basis of information regarding a district behavior recommendation obtained in the district behavior recommendation technology. A placement optimization function optimizes vehicle allocation on the basis of the behavior recommendation information and the congestion information. A path optimization function maximizes mobility use efficiency in the entire district on the basis of the behavior recommendation information and the congestion information.

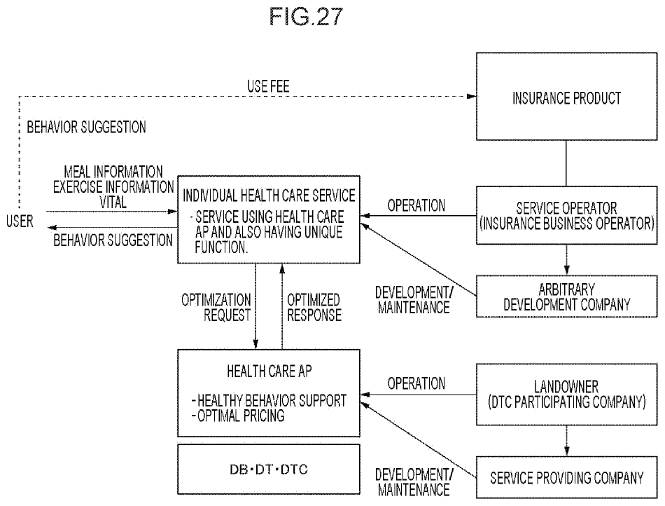

FIG. 27 illustrates an overview of a health care application (health care AP) provided by the service provider. The health care application provides functions of supporting healthy behavior and optimizing pricing and the like.

The landowner participating in the DTC (DTC participating company) operates the health care application by paying a development cost and a maintenance cost to the service providing company. The health care application is developed and maintained by the service providing company.

An individual health care service is operated by a service operator (insurance business operator) who provides an insurance product. The individual health care service uses a function of the health care application and has a unique function. The individual health care service may be developed and maintained by an arbitrary development company.

The user pays a use fee to the service operator to receive provision of an insurance product. The user provides personal information regarding health, such as meal information, exercise information, and vitals, for the individual health care service by using a communication device such as a smartphone. The individual health care service provides a behavioral suggestion for the user. When providing the behavioral suggestion for the user, the individual health care service issues an optimization request to the health care application. The health care application instructs the optimization device 10 to perform optimization processing in response to the request, acquires the index values of the digital twins optimized by the optimization device 10, and returns an optimized response to the individual health care service.

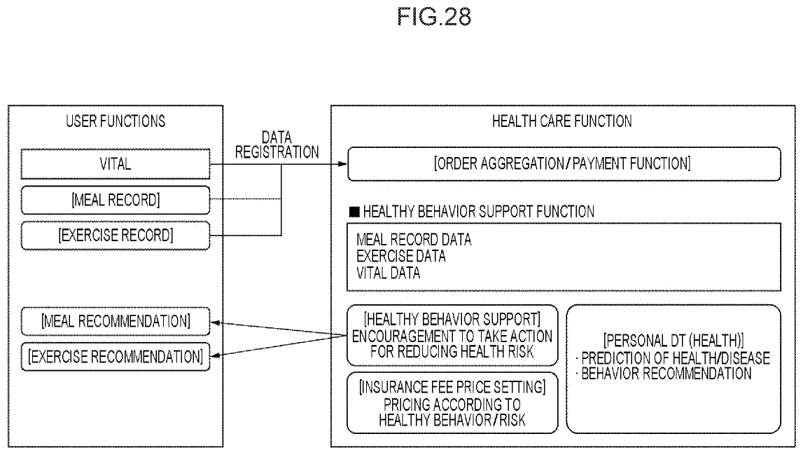

FIG. 28 illustrates a specific example of the health care application.

Functions for users of the health care application include a meal recording function, an exercise recording function, a meal recommendation function, and an exercise recommendation function.

A health care function of the health care application includes an order aggregation/payment function, a healthy behavior support function, and an insurance fee price setting function. The healthy behavior support function encourages the user to take an action for reducing a health risk. The insurance fee price setting function prices according to healthy behavior or a risk. The personal DT is used when the healthy behavior support function and the insurance fee price setting function are executed.

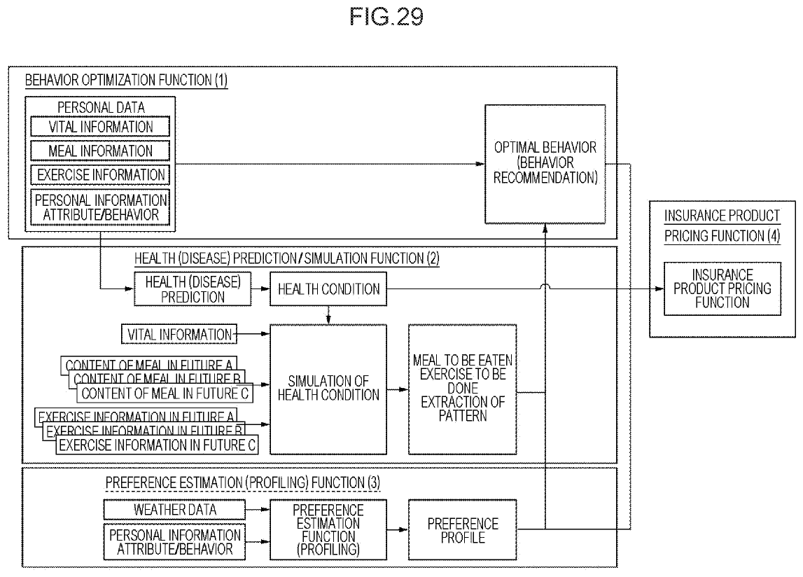

FIG. 29 is an explanatory diagram illustrating an example of a relationship between functions in a behavior recommendation technology.

The behavior optimization function has a function of outputting optimal behavior (behavior recommendation) and health condition prediction on the basis of vital information, meal information, and exercise information.

The behavior recommendation technology uses a health (disease) prediction/simulation function of outputting a health condition when the vital information, meal information, exercise information, and personal information (attribute and behavior) are input to derive optimal behavior. The health (disease) prediction/simulation function can simulate the health condition by changing contents of a meal and exercise with respect to certain specific personal information and can extract patterns of a meal to be eaten and exercise to be done.

When deriving optimal behavior, the behavior recommendation technology also uses preference estimation (profiling) function of estimating a personal preference on the basis of weather data and the personal information (attribute and behavior). The behavior recommendation technology further has an insurance product pricing function of deriving an optimal insurance price by inputting the health condition prediction, optimal behavior, and personal information (attribute) output from the behavior optimization function.

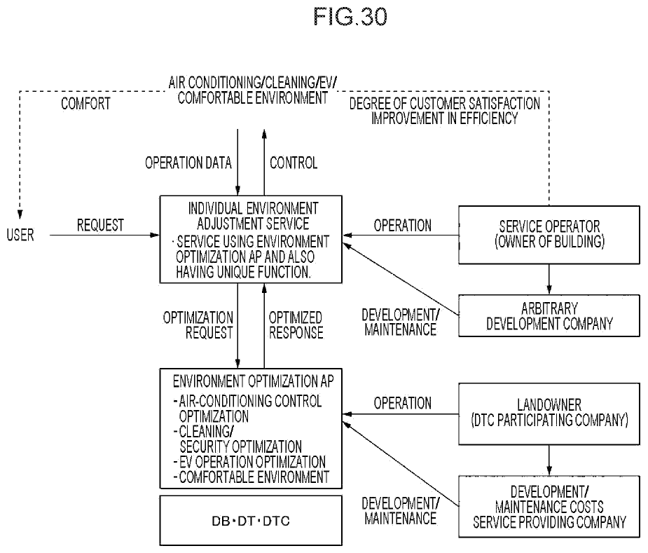

FIG. 30 illustrates an overview of an environment optimization application (environment optimization AP) provided by the service provider. The environment optimization application provides a function of optimizing air-conditioning control, a function of optimizing cleaning or security, a function of optimizing operation of an elevator, and a function of determining a comfortable environment.

The landowner participating in the DTC (DTC participating company) operates the environment optimization application by paying a cost to the service providing company. The environment optimization application is developed and maintained by the service provider.

A business operator who uses the environment optimization application pays an application fees to a service operator (e.g. owner of building). The service operator operates an individual environment adjustment service. The individual environment adjustment service uses a function of the environment optimization application and has a unique function. The unique service may be developed and maintained by an arbitrary development company.

The user issues a request for control of air conditioning, cleaning, an elevator, or a comfortable environment to the individual environment adjustment service by using the communication device such as a smartphone. In response to the request, the individual environment adjustment service provides comfort for the user by controlling the air conditioning, cleaning, elevator, or comfortable environment. The individual environment adjustment service issues an optimization request to the environment optimization application when controlling the air conditioning, cleaning, elevator, or comfortable environment. The environment optimization application instructs the optimization device 10 to perform optimization processing in response to the request, acquires the index values of the digital twins optimized by the optimization device 10, and returns an optimized response to the individual environment adjustment service.

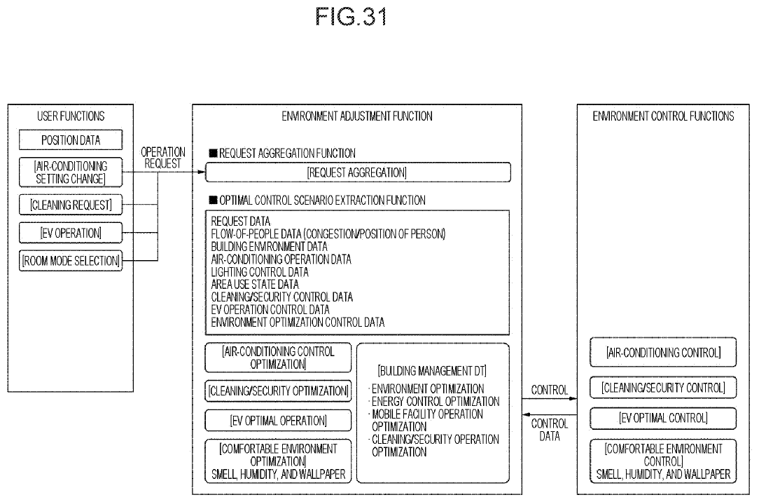

FIG. 31 illustrates a specific example of the environment optimization application.

The functions for users of the environment optimization application include an air-conditioning setting change function, a cleaning request function, an elevator operation function, and a room mode selection function.

The environment adjustment function of the environment optimization application includes a request aggregation function, an optimal control scenario extraction function, an air-conditioning control optimization function, a cleaning/security optimization function, an elevator optimal operation function, and a comfortable environment optimization function. A building management DT is used when the air-conditioning control optimization function, the cleaning/security optimization function, the elevator optimal operation function, and the comfortable environment optimization function are executed. The optimal control scenario extraction function extracts data illustrated in FIG. 31.

The environment control function of the environment optimization application includes an air-conditioning control function, a cleaning/security function, an elevator control function, and a comfortable environment control function.

When an operation request is transmitted from each function of the functions for users to the environment adjustment function, the request aggregation function aggregates the request and issues a request for control to the environment control function in response to the aggregated request. The environment control function transmits control data to the environment adjustment function.

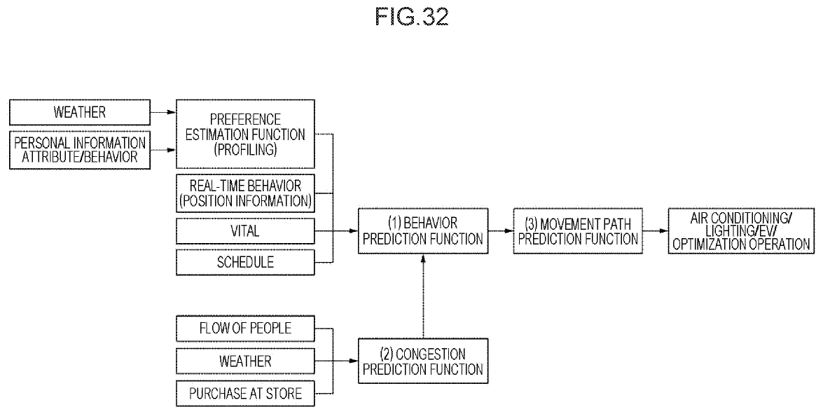

FIG. 32 is an explanatory diagram illustrating an example of a relationship between functions in an environment optimization technology.

The environment optimization technology optimizes an environment of a district or building for a visitor or office worker who visits the district on the basis of behavior prediction of the visitor or office worker in the district in consideration of congestion prediction of various places in the district. The behavior prediction is the same as the district behavior recommendation technology.

A behavior prediction function derives behavior prediction in the district on the basis of personal preference estimation, real-time behavior (position information), biological data, and schedule data in a case of the office worker. When deriving the behavior prediction in the district, the behavior prediction function considers a congestion status that the congestion prediction function predicts on the basis of the flow-of-people data, the weather data, and the store purchase data.

The environment optimization technology further has a movement route prediction function of predicting a movement path on the basis of the behavior prediction by the behavior prediction function. The movement route prediction function performs prediction control of devices in the district, such as air conditioning, lightings, and elevators on the path on the basis of a prediction result of the movement path.

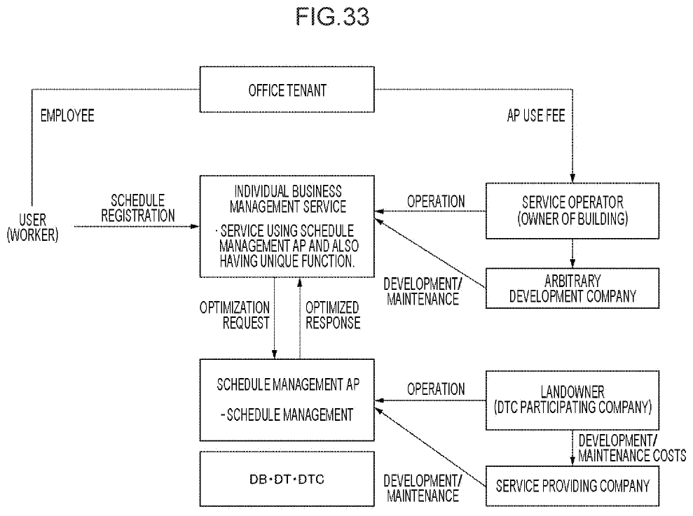

FIG. 33 illustrates an overview of a schedule management application (schedule management AP) provided by the service provider. The schedule management application provides a function of optimizing schedule management.

The landowner participating in the DTC (DTC participating company) operates the schedule management application by paying a cost to the service providing company. The schedule management application is developed and maintained by the service provider.

An office tenant that uses the schedule management application pays an application fees to the service operator. The office tenant is a tenant in which a company at which the user works as an employee is located. The service operator operates a schedule management service. An individual business management service uses a function of the schedule management application and has a unique function. The unique service may be developed and maintained by an arbitrary development company.

When the user registers a schedule in the individual business management service, the individual business management service issues an optimization request to the schedule management application. The schedule management application instructs the optimization device 10 to perform optimization processing in response to the request, acquires the index values of the digital twins optimized by the optimization device 10, and returns an optimized response to the individual business management service.

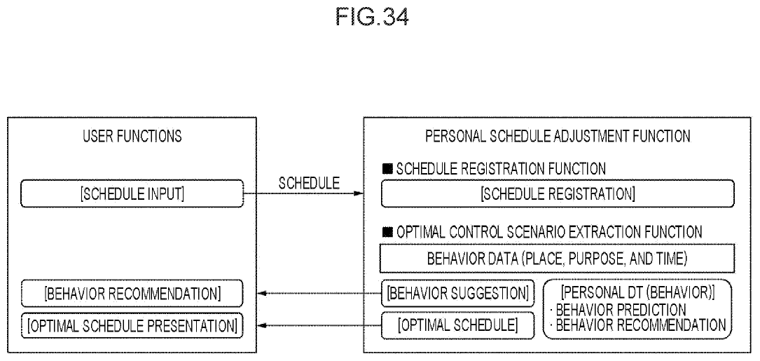

FIG. 34 illustrates a specific example of the schedule management application.

Functions for users include a schedule input function, a behavior recommendation function, and an optimal schedule presentation function.

A personal schedule adjustment function includes a schedule registration function, an optimal control scenario extraction function, a behavior suggestion function, and an optimal schedule function. The optimal control scenario extraction function extracts behavior data (place, purpose, and time) illustrated in FIG. 34. The personal DT is used when the behavior suggestion function and the optimal schedule function are executed.

When the schedule input function transmits a schedule input by the user to the personal schedule adjustment function, the schedule registration function registers the schedule transmitted from the schedule input function. Then, the behavior suggestion function recommends behavior to the user by using the personal DT. Further, the optimal schedule function recommends an optimal schedule to the user by using the personal DT.

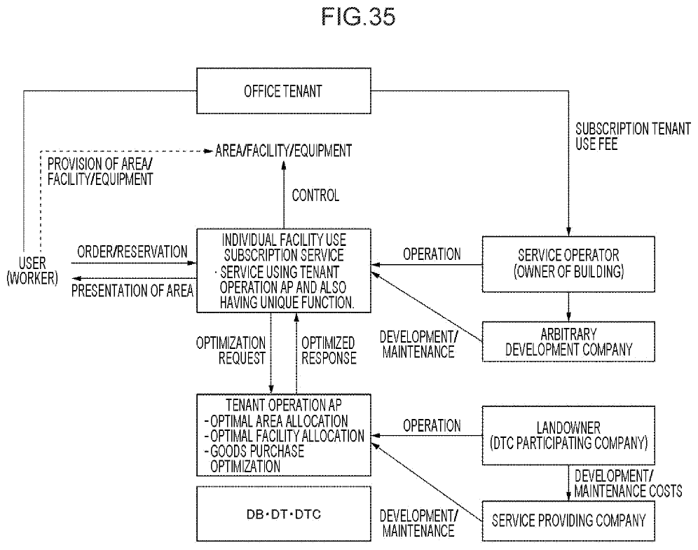

FIG. 35 illustrates an overview of a tenant operation application (tenant operation AP) provided by the service provider. The tenant operation application provides an optimal area allocation function, an optimal facility allocation function, and an optimal goods purchase function.

The landowner participating in the DTC (DTC participating company) operates the tenant operation application by paying a cost to the service providing company. The tenant operation application is developed and maintained by the service provider.

The office tenant that uses the tenant operation application pays an application fees to a service operator (e.g. owner of building). The service operator operates an individual facility use subscription service. The individual facility use subscription service uses a function of the tenant operation application and has a unique function. The individual facility use subscription service may be developed and maintained by an arbitrary development company.

When using the office tenant, the user receives provision of information regarding an available area from the individual facility use subscription service. When providing the information regarding the available area, the individual facility use subscription service issues an optimization request to the tenant operation application. The tenant operation application instructs the optimization device 10 to perform optimization processing in response to the request, acquires the index values of the digital twins optimized by the optimization device 10, and returns an optimized response to the individual facility use subscription service.

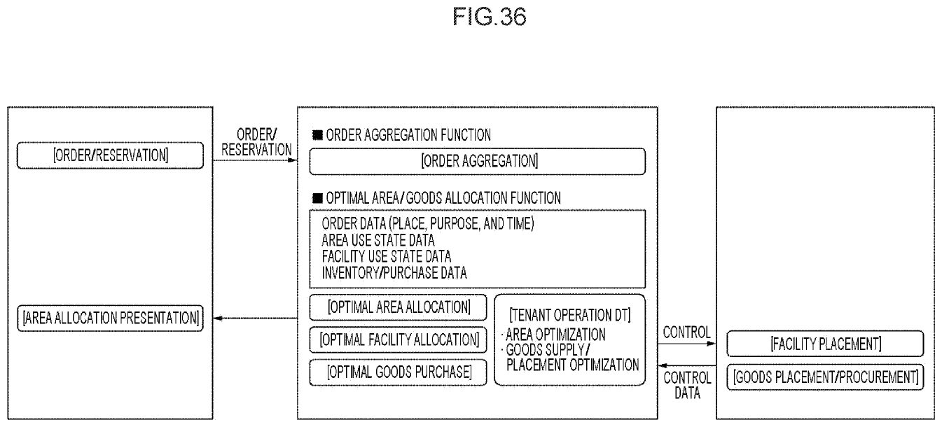

FIG. 36 illustrates a specific example of the tenant operation application.

Functions for users of the tenant operation application include an order/reservation function and an area allocation presentation function.

A tenant operation function of the tenant operation application includes an order aggregation function and an optimal area/allocation function. The optimal area/allocation function provides an optimal area allocation function, an optimal facility allocation function, and an optimal goods purchase function. The tenant operation DT is used when the optimal area allocation function, the optimal facility allocation function, and the optimal goods purchase function are executed.

A procurement/placement function of the tenant operation application includes a facility placement function and a goods placement/procurement function.

When the order aggregation function receives order/reservation information transmitted from the order/reservation function, the optimal area allocation function transmits optimal area information. The area allocation presentation function receives and presents the area information transmitted from the optimal area allocation function.

Further, the order aggregation function aggregates an order of a facility or goods transmitted from the order/reservation function and issues a request for control to the facility placement function or the goods placement/procurement function in response to the aggregated request. The facility placement function or the goods placement/procurement function transmits control data corresponding to the requested control to the tenant operation function.

There will be described examples where digital twins are linked by combining a plurality of functions among the functions described so far.

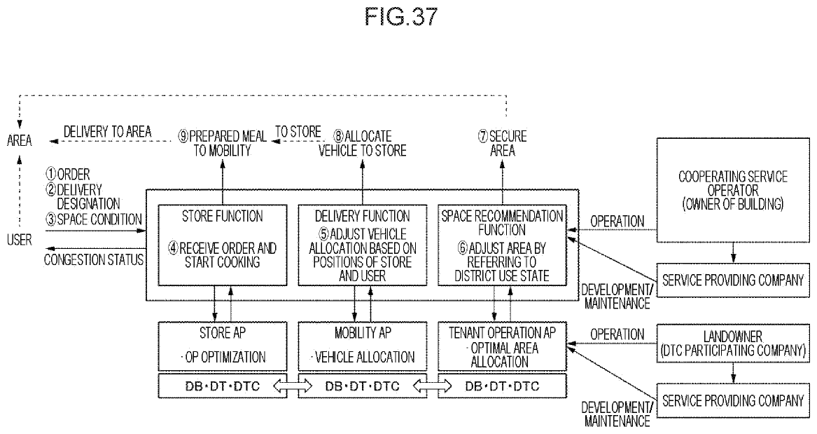

FIG. 37 illustrates an example of linking of digital twins. FIG. 37 illustrates an example where the digital twins are linked by combining the application for store operation, the mobility application, and the tenant operation application. Service operators are a store service operator, a mobility service operator, and a tenant operation service operator. A target user is a district user under a regular use tenant.

When the user orders a dish, the mobility digital twin, the tenant digital twin, and the store digital twin cooperate to grasp the congestion status of the store, an availability state of the mobility, and a use state of each area in the district and predict a state at each time in the future. A DTC layer derives a store visit time and waiting time from a combination of the prediction results. The DTC layer further selects a place to eat in the district and also derives an optimal mealtime and a delivery time by the mobility. By comparing the derived pieces of information, the DTC layer feeds back the optimal place and time to eat to the user.

Therefore, the user can receive a delivered meal at an optimal place at a good timing, without waiting at the store.

In the example of FIG. 37, cooperation between the store operation DT and the mobility DT can expand an option of the user to in-store use or out-of-store use and can perform operation optimization including the delivery time.

Further, in the example of FIG. 37, cooperation between the store operation DT and the tenant operation DT can expand the store when the store is congested and can secure a seat of the user in the district.

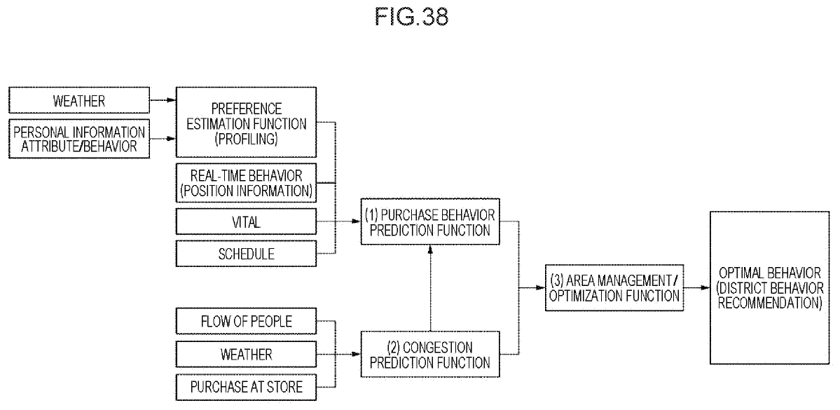

FIG. 38 is an explanatory diagram illustrating an example of a relationship between functions in the district behavior recommendation technology.

The district behavior recommendation technology recommends optimal behavior to a visitor or office worker who visits the district on the basis of behavior prediction of the visitor or office worker in the district and congestion prediction of various places in the district.

The behavior prediction in the district is derived by a purchase and other behavior prediction function on the basis of personal preference estimation (a function of the healthy behavior recommendation technology), real-time behavior (position information), biological data, and schedule data in a case of the office worker. When deriving the behavior prediction in the district, the purchase and other behavior prediction function considers the congestion status that the congestion prediction function derives on the basis of the flow-of-people data, the weather data, and the store purchase data.

The district behavior recommendation technology also performs an optimal path to a destination area, order of migration, an optimal movement time, a change of the destination area (optimal recommendation), and the like by using the area management/optimization function in consideration of the congestion status derived by the congestion prediction function.

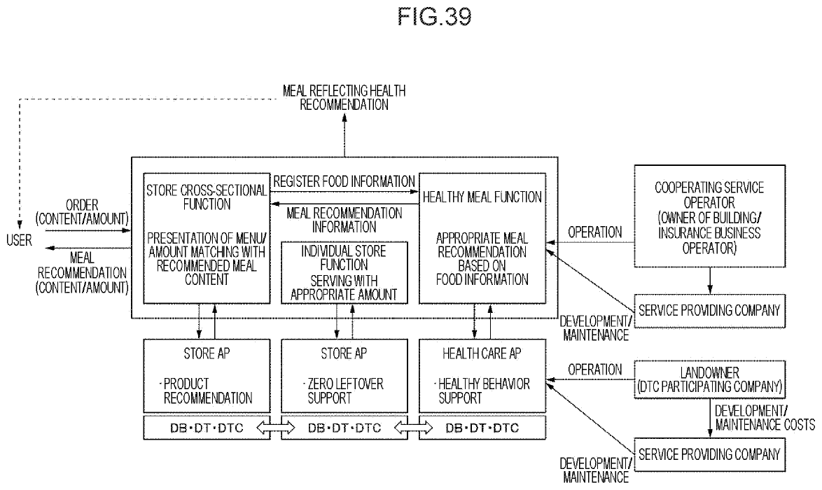

FIG. 39 illustrates another example of linking of digital twins. FIG. 39 illustrates an example where the digital twins are linked by combining the application for store operation and the health care application. Service operators are a store service operator and a health care service operator. A target user is a district user under a regular use tenant.

For a meal order of the user, the store digital twin and the personal service digital twin cooperate to predict a health condition in the personal digital twin and recommend an optimal meal to the user. The store digital twin prepares provision of a meal with specified content.

In the example of FIG. 39, a healthy meal function automatically registers an amount and content of the meal from the store data. Then, a store cross-sectional function presents recommended meal content as a menu and reflects the content and amount in the order. In the example of FIG. 39, it is possible to perform optimization that reflects the personal health condition by cooperation among the store operation DT, the food loss DT, and a health care DT.

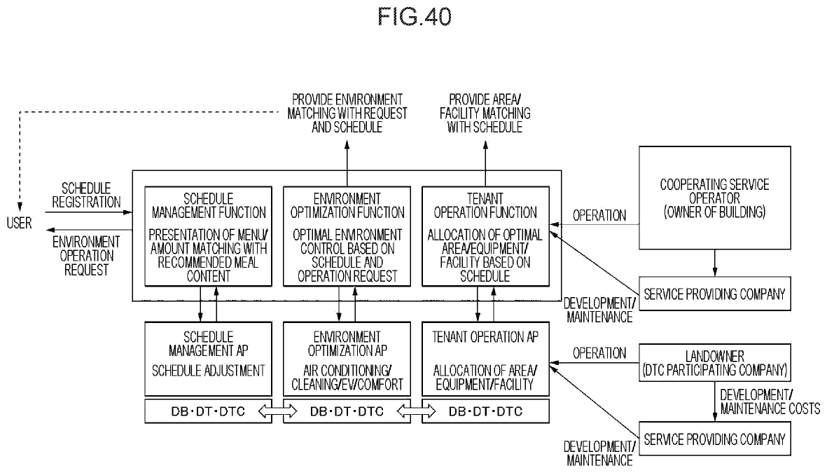

FIG. 40 illustrates another example of linking of digital twins. FIG. 40 illustrates an example where the digital twins are linked by combining the schedule management application, the environment optimization application, and the tenant operation application. Service operators are a schedule management service operator, an environment optimization service operator, and the tenant operation service operator. A target user is a district user under a regular use tenant.

For schedule registration of the user, a digital twin of a personal service, a digital twin for controlling air conditioning and providing a comfortable environment, and a tenant management digital twin for managing a tenant of a place to be used cooperate to predict an optimal condition according to the schedule. Further, each digital twin derives an optimal place to be used for the user in consideration of use states of a plurality of people and predicts an environment when the user uses the place.

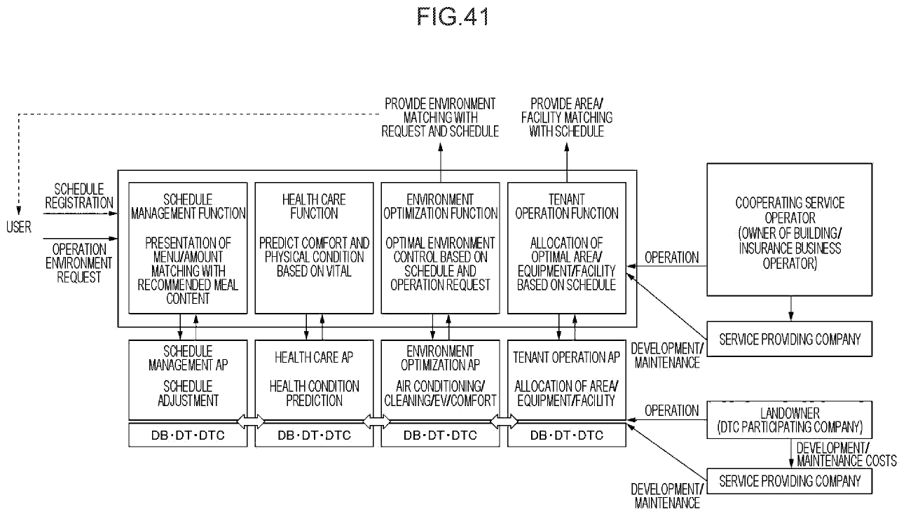

FIG. 41 illustrates another example of linking of digital twins. FIG. 41 illustrates an example where the digital twins are linked by combining the schedule management application, the health care application, the environment optimization application, and the tenant operation application. Cooperating service operators are the schedule management service operator, a health service operator, the environment optimization service operator, and the tenant operation service operator. A target user is a district user under a regular use tenant.

FIG. 41 illustrates an example of linkage in which, in order to derive an optimal environment, the example of FIG. 40 further cooperates with the personal service digital twin, thereby considering environment optimization based on grasping of a health condition and prediction of the health condition obtained when the environment is optimized.

In the example of FIG. 41, a personal service DT (health) and a personal service DT (behavior) cooperate to combine content of work and vitals of a person, and thus it is possible to suggest behavior for achieving the best work efficiency or to place equipment optimally.

In the example of FIG. 41, it is possible to optimize environment control that reflects a personal health condition by cooperating between the personal service DT and the building management DT.

Further, in the example of FIG. 41, by cooperating between the building management DT and the tenant operation DT, the area is considered to be expanded as means for responding to a personal request, and thus it is possible to provide an environment including behavior suggestion.

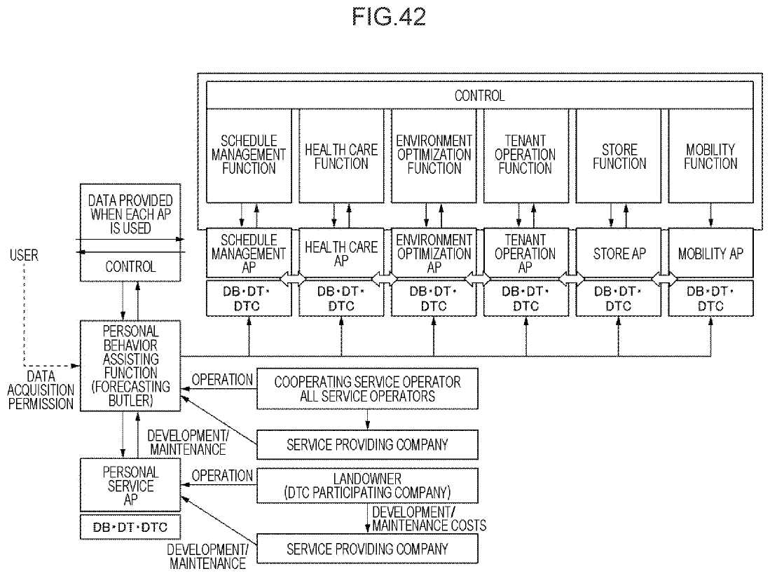

FIG. 42 illustrates another example of linking of digital twins. FIG. 42 illustrates an example where the digital twins are linked by combining the schedule management application, the health care application, the environment optimization application, the tenant operation application, the application for store operation, and the mobility application. Cooperating service operators are the schedule management service operator, the health service operator, the environment optimization service operator, the tenant operation service operator, the store service operator, and the mobility service operator. A target user is a district user under a regular use tenant.

A personal behavior assisting function grasps a state predicted in each digital twin until a certain set future time. Each digital twin includes the district management digital twin regarding an environment state of the district, the store digital twin regarding a state of the store, the tenant operation digital twin regarding a state of an office tenant, the mobility digital twin that grasps delivery and movement in the district, the food loss digital twin regarding optimization of purchase of a restaurant, and the personal service digital twin regarding vital information, position information, and an action schedule of a person. There is a state in which two or more digital twins are linked as in the examples described so far. The personal behavior assisting function that grasps a prediction state of each digital twin predicts and recommends an optimal personal behavior on the basis of the prediction state of each digital twin.

The personal behavior assisting function that recommends behavior of the user cross-sectionally aggregates reactions (effects) to control, such as what action the user has taken with respect to which application under what situation. The personal behavior assisting function can improve accuracy in issuing requests to a plurality of applications.

Use case examples of linkage of digital twins by a plurality of applications will be described.

(First Use Case)

The personal service DT extracts “lunch” as recommended behavior from information regarding a schedule and stress of the user by using an office behavior optimization function and estimates an optimal meal on the basis of the health condition of the user by using a health condition estimation function. The store operation DT checks a congestion status of a store, disables in-store use because the store is congested, and procures an area instead by using a congestion avoidance/operation optimization function. The store operation DT causes cooking of lunch ordered by the user to be started in the store.

In response to an area procurement request from the store operation DT, the tenant operation DT secures a currently available place that relieves the stress of the user in the district area. The mobility DT allocates a mobility to deliver the meal, selects a path of the mobility, and causes the mobility to start moving on the basis of a current position of each mobility and work by using an intra district movement support mobility optimization function.

The district management DT leads the user into taking an action within several minutes on the basis of a congestion status of an elevator hall on each floor by using a mobile facility operation optimization function, thereby moving the user efficiently. That is, when the user leaves a seat and heads to an elevator, a door opens without the user pressing a button, and the user can go to an area secured as a place for lunch. Then, when the user arrives at the area, the mobility delivers the meal at a right timing. The district management DT finishes cleaning before the user finishes the meal and returns to a room by using an automated/efficient cleaning function.

(Second Use Case)

There is a case where personal service DTs of two users A and B are built. The user A wants to visit a clothing store, and the user B wants to visit a restaurant. The personal service DT of the user A predicts a store to be visited by the user A by using the behavior prediction function, extracts a preference of the user A by using a purchase tendency estimation function, and is linked with a store operation DT of the store to be visited. The personal service DT of the user B predicts a store to be visited by the user B and migratory behavior of the user B by using the behavior prediction function, estimates appropriate meal content for the user B by using the health condition estimation function, and is linked with the food loss DT.

The store operation DT of the store to be visited by the user A predicts demand on the basis of an individual customer preference by using the congestion avoidance/operation optimization function and procures a product suitable for the visiting user in conjunction with a Logistics DT. Because the user preference and the store operation DT are linked, when the user A visits the store, a product that suits the size and preference of the user is prepared so that the user can try on the product.

The store operation DT of the store to be visited by the user B estimates congestion on the basis of behavior prediction of the user by using the congestion avoidance/operation optimization function. The store operation DT of the store to be visited by the user B is linked with the tenant operation DT to secure an area against shortage of the store area. Then, the store operation DT of the store to be visited by the user B starts procuring people for improving operation efficiency. The tenant operation DT allocates a necessary area on the basis of the congestion prediction of the store operation DT while making adjustment with other tenants by using a tenant area optimization function, thereby efficiently using the area. Because the user behavior and the store operation DT are linked, when the user B visits the store, the user is guided to a seat without waiting, and thus a comfortable meal environment is prepared in the store where clerks perform smooth operation without the user feeling congested. Because the health DT and the food loss DT are linked, it is possible to receive provision of a meal that reflects the health condition of the user B.

By linking the digital twins according to the present embodiment, it is possible to estimate behavior of the user and recommend appropriate behavior.

### First Proposal Example

In this proposal example, a proposal example of possible behavior when the user arrives at the district will be described. When the user arrives at the district, the district behavior recommendation technology predicts behavior of the user assumed based on a current point and a current time. Further, the district behavior recommendation technology predicts a state assumed based on vitals of the user when the user arrives at the district.

A district behavior recommendation function extracts optimal possible behavior for the user. Here, the district behavior recommendation technology extracts, as possible behaviors, using a second elevator in five minutes as a possible candidate x and going to buy a meal as a possible candidate y. The district behavior recommendation technology extracts optimal behavior corresponding to the prediction of the state assumed based on the vitals of the user. Here, the district behavior recommendation function extracts an action of having a meal.

Then, a building management optimization function calculates an optimal degree of each of the possible candidates x and y on the basis of a predetermined rule in demand forecast processing. For example, the building management optimization function calculates the optimal degree of the possible candidate x to be 40 and the optimal degree of the possible candidate y to be 60.

Then, the building management optimization function calculates the optimal degree of each of the possible candidate s x and y on the basis of a predetermined rule in operation control optimization processing. For example, the building management optimization function calculates the optimal degree of the possible candidate x to be 30 and the optimal degree of the possible candidate y to be 70.

Then, a store operation optimization function calculates the optimal degree of each of the possible candidates x and y on the basis of a predetermined rule. For example, the building management optimization function calculates the optimal degree of the possible candidate x to be 50 and the optimal degree of the possible candidate y to be 50.

Finally, the district behavior recommendation function adds up the optimal degrees of each of the possible candidates x and y obtained by the respective functions and presents a larger value to the user. In the example described above, the sum of the optimal degrees of the possible candidate x is 120, and the sum of the optimal degrees of the possible candidate y is 180. Therefore, the optimal degree of the possible candidate y is larger, and thus the district behavior recommendation technology recommends the possible candidate y, that is, an action of going to buy a meal to the user.

### Second Proposal Example

An office behavior recommendation function extracts possible meetings at a timing at which a meeting is assigned to members. Here, the office behavior recommendation function extracts, as the possible meetings, a meeting from 11:00 to 12:00 as a possible candidate a and a meeting from 17:00 to 18:00 as a possible candidate b.

Then, the district behavior recommendation technology predicts an action occurring in each of the above possible candidates. Here, the district behavior recommendation technology predicts that an action occurring in the possible candidate a is having a meal from 12:00 to 13:00 in the district and that an action occurring in the possible candidate b is no other action occurring in the district.

Then, a food loss function calculates the optimal degree of each possible candidate on the basis of a predetermined rule. For example, the food loss function calculates the optimal degree of the possible candidate a to be 100 and the optimal degree of the possible candidate b to be 0.

Then, a subscription office operation function calculates the optimal degree of each possible candidate on the basis of a predetermined rule. For example, the subscription office operation function calculates the optimal degree of the possible candidate a to be 90 and the optimal degree of the possible candidate b to be 10.

Then, the building management optimization function calculates the optimal degree of each possible candidate on the basis of a predetermined rule. For example, the building management optimization function calculates the optimal degree of the possible candidate a to be 10 and the optimal degree of the possible candidate b to be 90.

Finally, the office behavior recommendation function adds up the optimal degrees of each of the possible candidates a and b obtained by the respective functions and presents a larger value to the user. In the example described above, the sum of the optimal degrees of the possible candidate a is 120, and the sum of the optimal degrees of the possible candidate b is 180. Therefore, the optimal degree of the possible candidate b is larger, and thus the office behavior recommendation function recommends the possible candidate b, that is, an action of having a meeting from 17:00 to 18:00 to the user.

### Third Proposal Example

In this proposal example, a proposal example of possible behavior when use of elevators is optimized in the entire district will be described. Two users A and B simultaneously arrive at the district. The user A is a non-disabled person, and the user B is a wheelchair user.

First, the district behavior recommendation technology of a digital twin of the user A predicts behavior of the user A assumed based on a current place and a current time. Here, the district behavior recommendation technology of the digital twin of the user A predicts that the user A should use the second elevator in five minutes and stay in a room N in six minutes. The district behavior recommendation technology of a digital twin of the user B predicts behavior of the user B assumed based on a current place and a current time. Here, the district behavior recommendation technology of the digital twin of the user B predicts that the user B should use the second elevator in five minutes and stay in a room U in thirty minutes.

In this case, the building management optimization function determines that only either the user A or the user B can use the second elevator on the basis of the current demand forecasts and extracts, as a possible candidate, which of the users A and B is put on the second elevator. Here, the building management optimization function extracts putting the user A on the second elevator as a possible candidate x and putting the user B on the second elevator as a possible candidate y.

Then, the district behavior recommendation technology calculates an optimal degree of the user B taking the second elevator and heading for the room U in five minutes on the basis of a predetermined rule.

Then, the subscription office operation function calculates the optimal degree of the room U in five minutes on the basis of a predetermined rule. Here, the room U is used in five minutes, i.e., is still unusable, and thus the subscription office operation function calculates the optimal degree of the room U in five minutes to be 0.

Then, the district behavior recommendation functions of the digital twins of the respective users A and B calculate the optimal degrees of the possible candidates x and y. Here, the district behavior recommendation function of each digital twin calculates the optimal degree of the possible candidate x to be 100 and the optimal degree of the possible candidate y to be 0.

Then, the building management optimization function calculates the optimal degree of each of the possible candidates x and y. Here, the building management optimization function calculates the optimal degree of the possible candidate x to be 20 and the optimal degree of the possible candidate y to be 80.

Finally, the district behavior recommendation function adds up the optimal degrees of each of the possible candidates x and y obtained by the respective functions and presents a larger value to the user. In the example described above, the sum of the optimal degrees of the possible candidate x is 220, and the sum of the optimal degrees of the possible candidate y is 80. Therefore, the optimal degree of the possible candidate x is larger, and thus the district behavior recommendation function proposes optimizing the entire district by putting the user A on the second elevator first.

### Fourth Proposal Example

In this proposal example, a proposal example of an action to be taken at a timing at which it starts to rain suddenly in the district will be described.

First, the building management optimization function resets a demand forecast because a demand for cleaning changes due to a change in weather. Then, the building management optimization function predicts that a floor or the like becomes dirtier on the basis of repentance of the demand forecast and prediction of a flow of people in the future.

Then, the building management optimization function determines that a cleaning area should be limited to maintain comfort. Then, the subscription office operation function extracts possible areas that can be limited by a current demand forecast. Here, the subscription office operation function extracts limiting a certain entire area as a possible candidate x and limiting a half of the certain area as a possible candidate y.

Then, the subscription office operation function calculates the optimal degree of each of the possible candidates x and y in an optimal area allocation application on the basis of a predetermined rule. Here, the subscription office operation function calculates the optimal degree of the possible candidate x to be 50 and the optimal degree of the possible candidate y to be 50.

Then, the building management optimization function calculates the optimal degree of each of the possible candidates x and y on the basis of a predetermined rule in an environment control application. Here, the building management optimization function calculates the optimal degree of the possible candidate x to be 10 and the optimal degree of the possible candidate y to be 90.

Then, the building management optimization function calculates the optimal degree of each of the possible candidates x and y on the basis of a predetermined rule in an autonomous work robot control application. Here, the building management optimization function calculates the optimal degree of the possible candidate x to be 80 and the optimal degree of the possible candidate y to be 20.

Finally, the building management optimization function adds up the optimal degrees of each of the possible candidates x and y obtained by the respective functions and presents the limitation of the area having a larger value. In the example described above, the sum of the optimal degrees of the possible candidate x is 140, and the sum of the optimal degrees of the possible candidate y is 160. Therefore, the optimal degree of the possible candidate y is larger, and thus the building management optimization function proposes optimizing the entire district by limiting a half of the certain area.

Next, services that can be achieved by systematizing (modeling) a mutual influence between digital twins will be described below.

For example, functions such as facial recognition payment, movement support by using a tracking robot, and home delivery of an item purchased by the user can be achieved by using data acquired from a sensor placed in the real space or a digital space and data of behavior information, a user profile, traffic, a predicted and optimized route, predicted behavior, optimized delivery people, personal mobility, and the like.

According to the present embodiment, by combining such various functions, it is possible to provide the user with a service that allows the user to make a purchase without bringing anything to go and return.

The optimization processing, which is executed by the CPU reading software (program) in each embodiment described above, may be executed by various processors other than the CPU. Examples of the processors in this case include a programmable logic device (PLD) whose circuit configuration can be changed after manufacturing, such as a field-programmable gate array (FPGA), and a dedicated electric circuit that is a processor having a circuit configuration exclusively designed for executing specific processing, such as an application specific integrated circuit (ASIC). Further, the optimization processing may be executed by one of the various processors or may be executed by a combination of two or more processors of the same type or different types (e.g. a combination of a plurality of FPGAs or a combination of a CPU and an FPGA). Furthermore, a hardware structure of the various processors is, more specifically, an electric circuit in which circuit elements such as semiconductor elements are combined.

In each embodiment described above, the aspect in which the optimization program is stored (installed) in advance in the storage 14 has been described, but this is not restrictive. The program may be provided by being stored in a non-transitory storage medium such as a compact disk read only memory (CD-ROM), a digital versatile disk read only memory (DVD-ROM), and a universal serial bus (USB) memory. The program may be downloaded from an external device via a network.

Regarding the above embodiment, the following supplementary notes are further disclosed.

(Supplement 1)

An optimization device for optimizing a digital twin system including at least two digital twins, the optimization device including:
a memory; and
at least one processor connected to the memory, in which
the processor
acquires a first index value of a first digital twin in a case where a first parameter is given,
estimates a state of the first digital twin after the first parameter is given,
acquires the state of the first digital twin, a second index value of a second digital twin obtained in a case where the first parameter is given, and a state of the second digital twin, and
optimizes the first index value and the second index value.

(Supplement 2)

A non-transitory storage medium having stored thereon a program executable by a computer to execute optimization processing for optimizing a digital twin system including at least two digital twins, in which
the optimization processing includes
acquiring a first index value of a first digital twin in a case where a first parameter is given,
estimating a state of the first digital twin after the first parameter is given,
acquiring the state of the first digital twin, a second index value of a second digital twin obtained in a case where the first parameter is given, and a state of the second digital twin, and
optimizing the first index value and the second index value.

### REFERENCE SIGNS LIST

10 Optimization device
20 Information processing device
30 Device

1. An optimization device for optimizing a digital twin system including at least two digital twins, the optimization device comprising:
a memory; and
at least one processor connected to the memory,
wherein the processor is configured to
acquire a first index value of a first digital twin in a case where a first parameter is given;
estimate a state of the first digital twin after the first parameter is given;
acquire the state of the first digital twin, a second index value of a second digital twin obtained in a case where the first parameter is given, and a state of the second digital twin; and
optimizes the first index value and the second index value.

2. The optimization device according to claim 1, wherein:
the first digital twin is a digital twin of one person;
the second digital twin is a digital twin of an arbitrary store;
the state of the first digital twin is an action taken by the person; and
the state of the second digital twin includes at least a degree of congestion of the store.

3. The optimization device according to claim 2, wherein
the processor is further configured to give a second parameter for changing the state of the first digital twin to the first digital twin.

4. The optimization device according to claim 3, wherein
the second parameter is a time at which the first digital twin is to start moving or a parameter that can change the time at which the first digital twin is to start moving.

5. The optimization device according to claim 3, wherein
the processor is further configured to acquire the second index value of the second digital twin and the state of the second digital twin when the second parameter is given to the first digital twin.

6. The optimization device according to claim 1, wherein
the first index value is a degree of comfort of the first digital twin, and the second index value is a degree of customer satisfaction of the second digital twin.

7. An optimization method for optimizing a digital twin system including at least two digital twins, wherein
a computer
acquires a first index value of a first digital twin in a case where a first parameter is given,
estimates a state of the first digital twin after the first parameter is given,
acquires the state of the first digital twin, a second index value of a second digital twin obtained in a case where the first parameter is given, and a state of the second digital twin, and
optimizes the first index value and the second index value.

8. A non-transitory storage medium that stores a computer-executable program to execute an optimization processing for optimizing a digital twin system including at least two digital twins in which the optimization processing comprises:
acquiring a first index value of a first digital twin in a case where a first parameter is given,
estimating a state of the first digital twin after the first parameter is given,
acquiring the state of the first digital twin, a second index value of a second digital twin obtained in a case where the first parameter is given, and a state of the second digital twin, and
optimizing the first index value and the second index value.
